(19) United States
(12) Patent Application Publication
(10) Pub. No.: US 2025/0036326 A1
(43) Pub. Date: Jan. 30, 2025

(54) PRINTER

(71) Applicant: BROTHER KOGYO KABUSHIKI KAISHA, Nagoya (JP)

(72) Inventor: Rui NAKAYAMA, Gifu (JP)

(21) Appl. No.: 18/768,230

(22) Filed: Jul. 10, 2024

(30) Foreign Application Priority Data
Jul. 24, 2023 (JP) 2023-119734
Jul. 31, 2023 (JP) 2023-124054
Jul. 31, 2023 (JP) 2023-124055

(51) Int. Cl. G06F 3/12

(52) U.S. Cl. CPC G06F 3/1207; G06F 3/1232; G06F 3/1255; G06F 3/1287

(57) ABSTRACT

A printer performs printing based on a print instruction received from an external device and conforming to the IPP (Internet Printing Protocol) standard. The printer has a controller including a CPU and a memory. The CPU executes various processes according to a program read from the memory. The memory stores various programs and data including an IPP response program, an IPP print program, and notification information. The notification information includes a prohibition table, a solution table, a status table, and a reason table.

### REFERENCE TO RELATED APPLICATIONS

This application claims priorities from Japanese Patent Application No. 2023-119734 filed on Jul. 24, 2023, Japanese Patent Application No. 2023-124054 filed on Jul. 31, 2023, and Japanese Patent Application No. 2023-124055 filed on Jul. 31, 2023. The entire contents of the priority applications are incorporated herein by reference.

### BACKGROUND ART

The technical field disclosed in the present specification relates to a technique of notifying an external device of information from a printer.

In recent years, the printer can be controlled by a printing application program and/or a cloud-based print service in accordance with the IPP (Internet Printing Protocol) standard. For example, a procedure of notifying an IPP client, which generates a print job in accordance with the IPP standard, of information from a printer is known.

### SUMMARY

The inventor of the present disclosure has considered that the content of the information transmitted to the IPP client from the printer and the procedure associated with the notification can be improved.

A printer according to an aspect of the present disclosure is a printer configured to perform printing based on a print job received from an external device, in accordance with a plurality of setting values associated with the received print job, wherein the printer is configured to: notify the external device of resolution information in response to a first request from the external device, the resolution information being information to resolve a combination of setting values not to be associated with each other at a same time, the resolution information being information in which a specific setting value is set for a predetermined setting item, the specific setting value indicating that the printer replace the specific setting value with another setting value; select one setting value in accordance with a situation of the printer from a plurality of setting values with which the specific setting value is replaceable, in a case where the printer has notified the external device of the resolution information in response to the first request from the external device and then the printer receives a print job having the specific setting value set from the external device; and perform the printing based on the print job in accordance with the one setting value which has been selected.

A printer according to another aspect of the present disclosure is a printer configured to perform printing based on a print job received from an external device, wherein the printer is configured to: notify the external device of a state code indicating a current state of the printer, in response to a first request from the external device; notify the external device of a reason code indicating a reason for the current state of the printer, in response to a second request from the external device; and notify the external device of a first printer state message in which a state message and a reason message are combined, in response to a third request from the external device, the state message being composed in natural language indicating the current state of the printer, the reason message being composed in the natural language indicating the reason for the current state of the printer.

A printer according to still another aspect of the present disclosure is a printer configured to perform printing based on a print job received from an external device, wherein the printer is configured to: notify the external device of a state code indicating a current state of a predetermined job inputted to the printer, in response to a first request from the external device with respect to the predetermined job; notify the external device of a reason code indicating a reason for the current state of the predetermined job, in response to a second request from the external device with respect to the predetermined job; and notify the external device of a first job state message in which a state message and a reason message are combined, in response to a third request from the external device with respect to the predetermined job, the state message being composed in natural language indicating the current state of the predetermined job, the reason message being composed in the natural language indicating the reason for the current state of the predetermined job.

A control method, a computer program, and a computer-readable storage medium storing the computer program for realizing the above-described functions of the printer are also new and useful.

According to the technique disclosed in the present specification, a printer which flexibly resolves the prohibition setting in the printer is realized. Further, a suitable procedure for generating a message outputted from the printer to the client and indicating the state of the printer is realized. Furthermore, a suitable procedure for generating a message outputted from the printer to the client and indicating the state of the job is realized.

### BRIEF DESCRIPTION OF DRAWINGS

FIG. 1 is a schematic view depicting a configuration of a printer.

FIGS. 2A and 2B are a flowchart depicting a procedure of a prohibition notifying process.

FIG. 3 is a diagram depicting an example of a prohibition table.

FIG. 4 is a diagram depicting an example of a resolution table.

FIG. 5 is a flowchart depicting a procedure of a printing process.

FIGS. 6A and 6B are a flowchart depicting a procedure of a sheet feed tray selecting process.

FIGS. 7A and 7B are a flowchart depicting a procedure of a sheet discharge tray selecting process.

FIGS. 8A and 8B are a flowchart depicting a procedure of a notifying process.

FIG. 9 is a flowchart depicting a procedure of a message generating process.

FIG. 10 is a view depicting an example of a state table.

FIG. 11 is a view depicting an example of a reason table.

FIGS. 12A, 12B and 12C are views each depicting an example of a response message which is generated.

FIG. 13A is a view depicting an example of a message displayed on an operation panel and FIG. 13B is a view depicting an example of a message displayed on a terminal device.

FIG. 14A is a view depicting an example of a message displayed on the operation panel and FIG. 14B is a view depicting an example of a message displayed on the terminal device.

FIG. 15A is a view depicting an example of a message displayed on the operation panel and FIG. 15B is a view depicting an example of a message displayed on the terminal device.

FIGS. 16A and 16B are a flowchart depicting a procedure of a notifying process.

FIG. 17 is a flowchart depicting a procedure of a message generating process.

FIG. 18 is a view depicting an example of a state table.

FIG. 19 is a view depicting an example of a reason table.

FIG. 20 is a view depicting an example of a message displayed on the terminal device.

FIG. 21 is a view depicting an example of a message displayed on the operation panel.

### DESCRIPTION

### First Embodiment

Conventionally, a printer has a plurality of setting items such as sheet type setting, sheet feed tray or sheet discharge tray setting, double-sided printing setting, post-process setting, etc. Depending on the setting items, however, there is a combination of setting values which should not be associated with each other at a same time. A setting of such a combination is referred to as a “prohibition setting”. In a case of using a printer driver provided by a printer vendor, information about the prohibition setting can be retained in a program in advance, and the input of the prohibition setting can be restricted by a client generating a print job, for each printer to be controlled.

In recent years, a printing application program and/or a cloud-based print service can control the printer in accordance with the IPP (Internet Printing Protocol) standard. In printing according to the IPP standard, the above-described printer driver is not used, and in an IPP client generating the print job in accordance with the IPP standard, the prohibition setting for each of the printers as described above is not clear in some cases.

Regarding the above-described problem, a procedure for transmitting information on prohibition setting from a printer to an IPP client and a procedure for transmitting information on an alternative setting which is a substitute setting to solve the problem of prohibition setting are known.

In a case where the information about the alternative setting is transmitted from the printer to the client, the client transmits a print job in accordance with the alternative setting to the printer. As a result, the printer performs control in accordance with the predetermined alternative setting. The inventor has considered that the prohibition setting is preferably avoided through a control suitable to the situation of the printer at the time of executing the print job.

In the following, a first embodiment embodying a printer will be described in detail with reference to the accompanying drawings. The present embodiment discloses a printer which can execute printing based on a printing instruction according to the IPP (Internet Printing Protocol) standard. In the present specification, the terms of “setting item” and “setting value” are described simply as “setting”, in some cases.

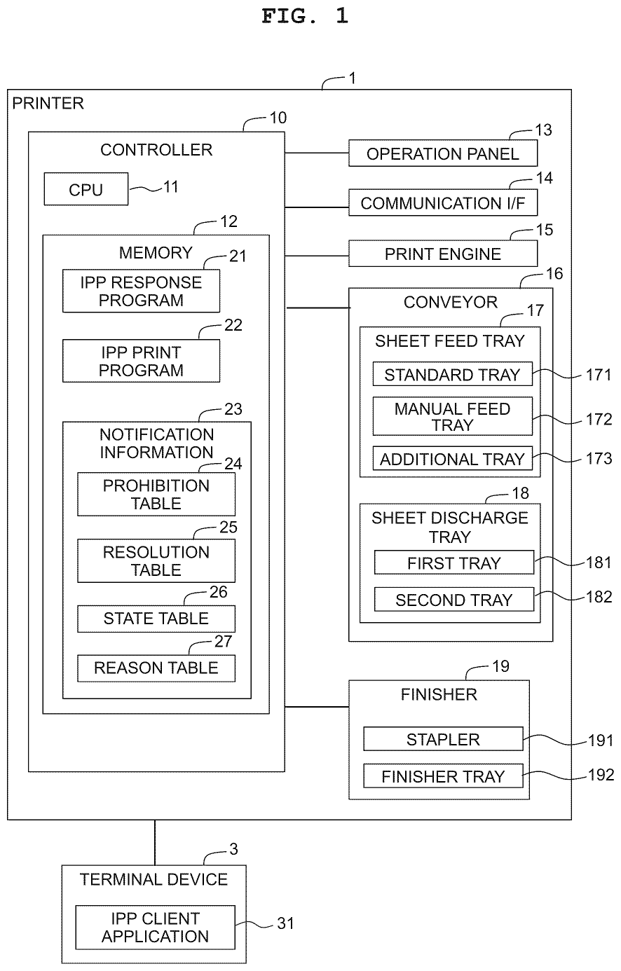

A printer 1 of the present embodiment includes a controller 10 including a CPU 11 and a memory 12, as depicted in FIG. 1. The printer 1 also includes an operation panel 13, a communication interface (hereinafter referred to as “communication I/F”) 14, a print engine 15, a conveyor 16, and a finisher 19, which are electrically connected to the controller 10.

The CPU 11 executes various processes in accordance with a program read from the memory 12, and/or based on an operation by a user. Note that the controller 10 in FIG. 1 is a general term for hardware and software used to control the printer 1, and does not necessarily represent a single piece of hardware which actually exists in the printer 1.

The memory 12 of the printer 1 of the present embodiment has various programs and various data including an IPP response program 21, an IPP print program 22, and notification information 23 stored therein in advance. The notification information 23 includes a prohibition table 24, a resolution table 25, a state table 26 and a reason table 27. Note that the IPP response program 21 and the IPP print program 22 may be composed to be included in one program. Note that in the present embodiment, the notification information 23 may not include the state table 26 and the reason table 27. The details of each of the programs and data will be described later. The memory 12 is also used as a work area in a case where the various processes are executed.

An example of the memory 12 is not limited to a ROM, a RAM, an HDD, etc., built into the printer 1, and may be a storage medium which is readable and writable by the CPU 11. For example, an external memory such as a USB memory or an HDD connected to the printer 1 via the communication I/F 14, or a memory or an HDD mounted on a device connected to the printer 1 via the communication I/F 14 are also examples of the memory 12. A buffer included in the CPU 11 is also an example of the memory 12.

Note that the computer-readable storage medium is a non-transitory medium. In addition to the above-described examples, the non-transitory medium also includes a storage medium such as a CD-ROM and a DVD-ROM. Further, the non-transitory medium is also a tangible medium. On the other hand, an electrical signal which carries a program downloaded from a server on the Internet and the like is a type of computer-readable signal medium but is not included in the non-transitory and computer-readable storage medium.

The operation panel 13 includes hardware which displays a screen for notifying the user of information, and hardware which receives an operation by the user. The operation panel 13 may include a touch panel having a notification function and an operation reception function. The operation panel 13 may include a display lamp, various buttons, and a numeric keypad.

The communication I/F 14 includes hardware for communicating with an external device such as a terminal device 3. The communication standard of the communication I/F 14 includes Ethernet (a trademark of FUJIFILM Business Innovation Corp. registered in Japan), Wi-Fi (a registered trademark of Wi-Fi Alliance), and USB. The printer 1 may include a plurality of communication I/Fs 14 which supports a plurality of communication standards.

The print engine 15 includes a configuration which prints an image based on image data on a print medium such as a sheet. A printing system of the print engine 15 is, for example, an electrophotographic system or an ink-jet system. The print engine 15 may be configured to perform color printing or may be configured to perform monochrome printing.

The conveyor 16 is a mechanism configured to convey the print medium, such as the sheet, via the print engine 15. The conveyor 16 includes a sheet feed tray 17 which stores sheets to be printed, a sheet discharge tray 18 which stores the printed sheets, and a plurality of conveying rollers. The printer 1 includes a plurality of trays as each of the sheet feed tray 17 and the sheet discharge tray 18. Specifically, the printer 1 includes, for example, a standard tray 171, a manual feed tray 172, and an additional tray 173, as the sheet feed tray 17. Further, the printer 1 includes, for example, a first tray 181 and a second tray 182, as the sheet discharge trays 18.

The finisher 19 is a configuration to be attached to the printer 1 in order to perform a post-process on the printed sheet and discharge the sheet. The printer 1 has the finisher 19 including, for example, a stapler 191 and a finisher tray 192.

The printer 1 of the present embodiment can communicate with the terminal device 3 via the communication I/F 14. The terminal device 3 is, for example, a smartphone, a tablet terminal, or a personal computer, and includes an application program (hereinafter referred to as “IPP client application”) 31 which can execute various processes in accordance with the IPP standard. By executing the IPP client application 31, the terminal device 3 as the IPP client can transmit an instruction regarding the printing to the printer 1. The terminal device 3 is an example of the external device.

Next, an operation regarding the IPP printing by the printer 1 will be described with reference to a flowchart. Note that the following processes basically indicate processes performed by the CPU 11 in accordance with instructions described in the program. That is, the processes such as “determination”, “extraction”, “selection”, “calculation”, “decision”, “specification”, “obtainment”, “reception”, and “control” in the following description represent the processes performed by the CPU 11. The processes by the CPU 11 also include hardware control using an API of the OS. In the present specification, the operation of each of the programs will be described, while the description of the OS will be omitted. That is, in the following description, such a statement that “program B controls hardware C” may also indicate that “program B controls hardware C by using an API of the OS”. Further, the process of the CPU 11 in accordance with the instructions written in the program may be described in abbreviated terms. For example, there may be such an expression “the CPU performs” or “performed by the CPU”. Further, the process of the CPU 11 in accordance with the instruction written in the program may be described in words such as “the program A performs” or “performed by the program A”, omitting the CPU.

Note that the “obtainment” is used as a concept which does not require a request. That is, the process in which the CPU 11 receives data without requesting the data is also included in the concept of “the CPU obtains data”. Further, “data” in the present specification is represented by a computer-readable bit string. Furthermore, multiple data with substantially the same meaning but in different formats shall be treated as the same data. The same applies also to “information” in the present specification. Furthermore, “request” and “instruct” are concepts that indicate outputting information indicating a request is being made and/or information indicating an instruction is being made to a recipient of the request and instruction. Moreover, the information indicating the request is being made and the information indicating that the instruction is being made are simply referred to as the “request” and the “instruction”, respectively. In the present specification, the terms “notify”, “notification”, “notifying”, “respond”, “response”, “responding”, etc., mean not only communication of information to a user but also communication and/or exchange of information between apparatuses or between components in an apparatus. Note that components in an apparatus includes software.

Further, a process of determining whether “information A indicates a matter B” by the CPU 11 may be conceptually described as “determining whether matter B is or not, based on information A”. A process of determining made by the CPU 11 whether the information A indicates the matter B or a matter C may be described conceptually such as “determining whether matter B or matter C, based on information A”.

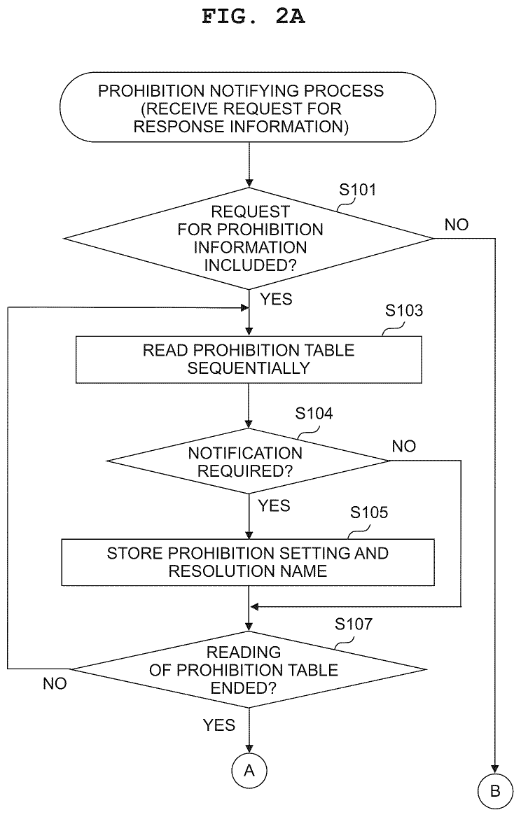

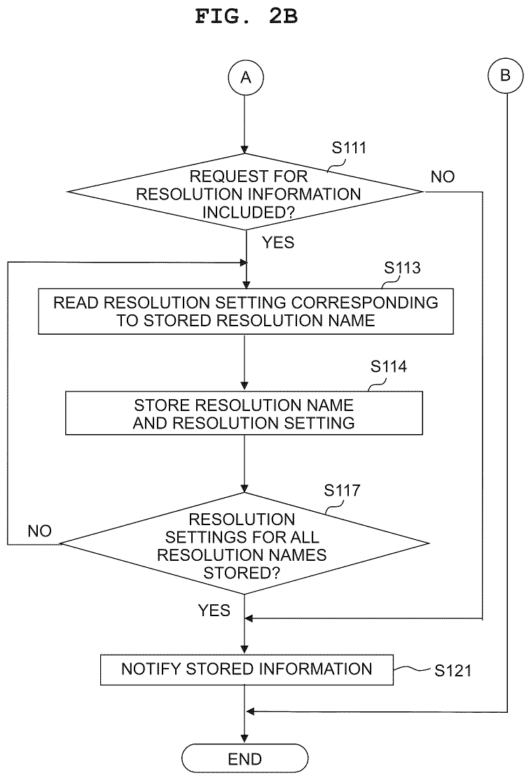

A prohibition notifying process executed by the printer 1 will be described with reference to the flowchart of FIGS. 2A and 2B. The CPU 11 of the printer 1 executes the prohibition notifying process based on the IPP response program 21 upon receiving a request for response information from the external device such as the terminal device 3.

Note that the IPP client application 31 has a function of communicating with a printer to be controlled and requesting the printer to transmit information. The IPP client application 31 may, for example, request the printer which is caused to execute printing to transmit the information at a timing such as before transmitting a printing instruction, and may generate a print job by using the responded information, in some cases. For example, in a case where the printer 1 receives the request for the response information from the terminal device 3, the printer 1 can generate the requested information and respond to the terminal device 3 based on a command included in the request for the response information.

The CPU 11 determines whether the received request for the response information includes a request for prohibition information (step S101). The prohibition information is information regarding a combination of setting values which should not be associated with each other at a same time. The printer 1 transmits the prohibition information to the IPP client application 31. The request for the prohibition information based on the IPP standard is, for example, a “job-constraints-supported” command. The request for the prohibition information is an example of a “second request”.

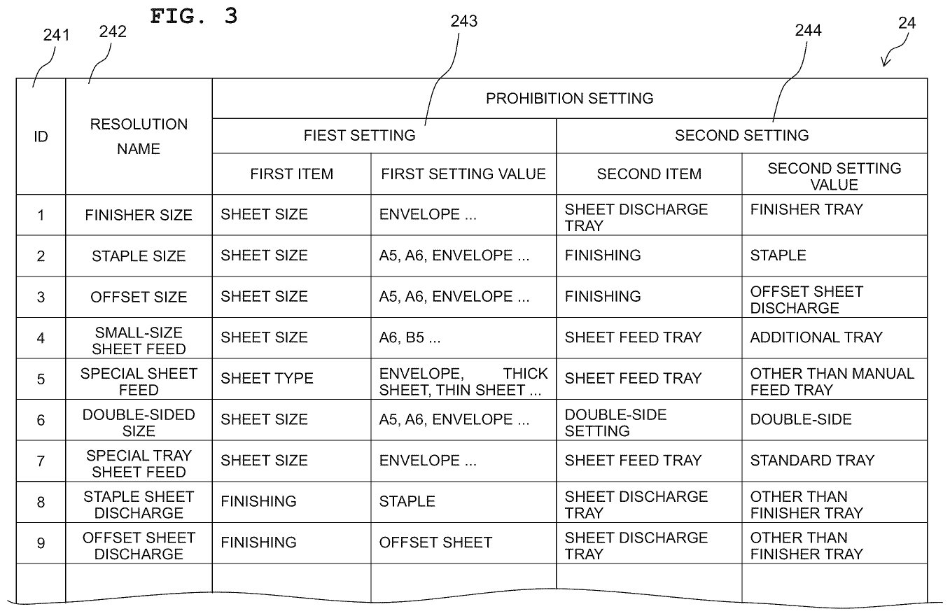

In a case where the CPU 11 determines that the request for the prohibition information is included in the received request for the response information (step S101: YES), the CPU 11 reads a record having an ID of “1” from the prohibition table 24 included in the notification information 23 stored in the memory 12 (step S103). Afterwards, every time the CPU 11 executes step S103, the CPU 11 reads a record or records which has (have) not been read yet, one at a time in the order of ID. In the memory 12 of the printer 1, the prohibition table 24 and the resolution table 25 are prepared in advance, as depicted in FIG. 1. For example, as depicted in FIG. 3, the prohibition table 24 stores combinations of setting values which might be responded as the prohibition information. Note that the prohibition table 24 depicted in FIG. 3 is a part of the prohibition table 24 stored in the printer 1. The prohibition table 24 includes a large number of records, in addition to those depicted in FIG. 3.

Each of the records of the prohibition table 24 includes an information ID 241, a resolution name 242, and a combination of a first setting 243 and a second setting 244, as a combination of setting values. The information ID 241 is an identification code which identifies each of the records included in the prohibition table 24. The resolution name 242 is a name corresponding to one of resolution names 252 included in the resolution table 25. Note that the resolution table 25 is a table stored in the notification information 23 while being associated with the prohibition table 24. Each of the first setting 243 and the second setting 244 is information composed of a setting item and a setting value set for the item.

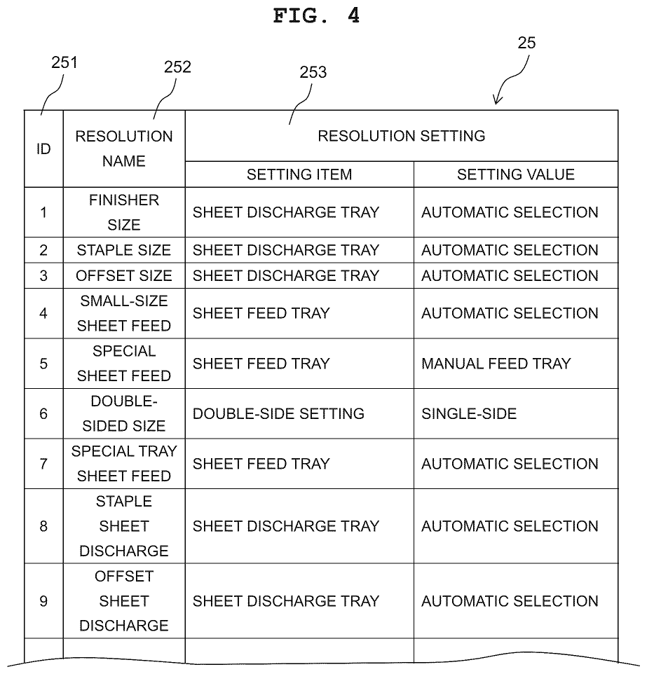

Further, the resolution table 25 is, for example, a table storing resolution information records each corresponding to one of the prohibition information records, as depicted in FIG. 4. Note that the resolution table 25 depicted in FIG. 4 is a part of the resolution table 25 stored in the printer 1. The resolution table 25 includes a large number of records, in addition to those depicted in FIG. 4.

Each of the records of the resolution table 25 includes an information ID 251, a resolution name 252, and a resolution setting 253. The information ID 251 is an identification code which identifies each of the records included in the resolution table 25. The resolution name 252 is one of the resolution names 242 of the prohibition table 24. The resolution setting 253 is information indicating a setting value recommended as a setting value of an object to be changed. The resolution setting 253 is information composed of a combination of a setting item and a setting value set for the item.

Although a detailed description will be provided later, in response to the request from the IPP client application 31, the printer 1 transmits, to the IPP client application 31, information indicating each of the records of the prohibition table 24 and information indicating each of the records of the resolution table 25. In a case where the IPP client application 31 receives a setting instruction for a prohibition setting stored in a certain record of the prohibition table 24, the IPP client application 31 can specify, from the resolution table 25, a record including the same resolution name as in the resolution name 242 included in the certain record, and use a resolution setting included in the specified record as the setting value for the object to be changed. Note that details of each of the records of the prohibition table 24 and the resolution table 25 will be described later.

Then, the CPU 11 determines whether the read record of the prohibition table 24 is information that notification is required (step S104). In a case where both the first setting 243 and the second setting 244 are valid setting values in the printer 1, the CPU 11 determines that the record is information that notification is required. For example, in a case where the finisher 19 is not attached to the printer 1, the CPU 11 determines that a record, in which either the first setting 243 or the second setting 244 is a setting related to a post-process using the finisher 19, is not information that notification is required.

In a case where the CPU 11 determines that the record is the information that notification is required (step S104: YES), the CPU 11 stores, in the memory 12, a combination of the first setting 243 and the second setting 244, which is the prohibition setting included in the certain record in the prohibition table 24, and the resolution name 242, while associating the resolution name 242 with the combination, as response information to the request for the prohibition information (step S105). The combination of the first setting 243 and the second setting 244 is information indicating a combination of setting values which is to be responded to as the prohibition information.

After step S105, or in a case where the CPU 11 determines that the record is not information that the notification is required (step S104: NO), the CPU 11 determines whether the reading of all the records in the prohibition table 24 has been ended (step S107). In a case where the CPU 11 determines that the reading of all the records has not been ended (step S107: NO), the process returns to step S103 and the CPU 11 reads the next record from the prohibition table 24.

In a case where the CPU 11 determines that all the records have been read (step S107: YES), the CPU 11 determines whether the request for the response information received from the terminal device 3 includes a request for resolution information (step S111). The resolution information is information regarding a setting value recommended as a resolution method in a case where the setting including the combination of setting values responded as the prohibition information is received. In a case where the request for the response information includes the request for the resolution information, the printer 1 can respond to the IPP client application 31 with the resolution information while associating the resolution information with the combination of the setting values which has been responded as the prohibition information. The request for the resolution information based on the IPP standard is, for example, a “job-resolvers-supported” command. The request for the resolution information is an example of a “first request”. Note that in accordance with the IPP standard, the resolution information is requested together with the request for the prohibition information.

In a case where the CPU 11 determines that the request for the resolution information is included in the received request for the response information (step S111: YES), the CPU 11 reads out, from the resolution table 25 stored in the memory 12, information corresponding to the resolution name 242 included in each of the records of the prohibition information stored in step S105 (step S113).

In step S113, the CPU 11 specifies a record in the resolution table 25 including the resolution name 252 which corresponds to the resolution name 242 of the prohibition information stored in step S105, and reads the resolution setting 253 of that record. Then, the CPU 11 associates the resolution name 252 with the resolution setting 253 read in step S113 and stores the resolution name 252 and the resolution setting 253 as response information to the request for the resolution information (step S114). Then, the CPU 11 determines whether the resolution setting 253 has been stored for each of the resolution names 242 of the response information stored in step S105 (step S117).

In a case where the CPU 11 determines that a resolution name 242 for which the resolution setting 253 is not stored still remains (step S117: NO), the process returns to step S113 and the CPU 11 reads a resolution setting 253 corresponding to the next resolution name 242.

In a case where the CPU 11 determines that the request for the response information received from the terminal device 3 does not include the request for the resolution information (step S111: NO), or determines that the resolution settings 253 are stored for all the resolution names 242 of the response information stored in step S105 (step S117: YES), the CPU 11 notifies the terminal device 3 of the response information stored in the memory 12 (step S121). Note that the CPU 11 can collect various types of information requested by the request for the response information and transmit the information to the terminal device 3 via the communication I/F 14 by the communication based on the IPP standard.

After step S121, or in a case where the CPU 11 determines that the received request for the response information does not include the request for the prohibition information (step S101: NO), the CPU 11 ends the prohibition notifying process.

In a case where the terminal device 3 receives the response information with respect to the transmitted request for the response information, the terminal device 3 passes the received information to the IPP client application 31. The IPP client application 31 can use the information to generate the print job. For example, in a case where the IPP client application 31 receives an instruction of a print setting which includes the combination of setting values included in the prohibition information after receiving the prohibition information as the response information to the request for the response information, the IPP client application 31 can warn the user.

Further, for example, in a case where the IPP client application 31 receives the prohibition information and the resolution information as the response information to the request for the response information, and then receives the instruction of the print setting including the combination of setting values included in the prohibition information, the IPP client application 31 can suggest a change to the setting value(s) indicated in the resolution information. Alternatively, for example, in a case where the IPP client application 31 receives the prohibition information and the resolution information as the response information to the request for the response information, and then receives the instruction of the print setting including the combination of setting values included in the prohibition information, the IPP client application 31 can automatically change the setting values to the setting values indicated in the resolution information. However, the method of utilizing the information depends on the IPP client application 31.

Note that in the prohibition notifying process, the resolution name 242 and the prohibition setting are transmitted as the prohibition information, and the resolution name 252 and the resolution setting are transmitted as the resolution information. However, instead of the resolution name 242 and the resolution name 252, the information ID 241 and the information ID 251 may be transmitted. In this case, the information ID 241 and the information ID 251 are an example of “first identification information” or “second identification information”. The resolution name or the information ID is the information for associating each of the records of the prohibition information with each of the records of the resolution information, and common information for the prohibition information and the resolution information may be used.

The printer 1 can perform notification of the prohibition information. The prohibition information indicates a combination of setting values, in which at least one of the setting values is not reflected in the printing process in a case where the setting values are set at the same time. For example, in a case where a sheet size suitable for double-sided printing is limited in the printer 1, the printer 1 cannot perform printing while simultaneously satisfying a setting value indicating the sheet size unsuitable for the double-sided printing and a setting value indicating the double-sided printing. Therefore, the printer 1 performs notification of the combination of setting values which cannot be satisfied simultaneously as the prohibition information, for example, as indicated in the record in which the ID 241 is “6” in FIG. 3. Further, as the resolution information associated with the prohibition information in this example, the printer 1 performs notification of, for example, a setting value indicating single-sided printing, as indicated in the record in which the ID 251 is “6” in FIG. 4.

The printer 1 performs notification of the prohibition information and the resolution information. Therefore, in a case where the setting value indicating the sheet size unsuitable for the double-sided printing and the setting value indicating the double-sided printing are set at the same time in the printing by the printer 1, the IPP client application 31 can urge the user to change the double-sided printing to the single-sided printing.

The printer 1 of the present embodiment may perform notification of not only the combination of setting values which cannot be satisfied simultaneously, but also a combination of setting values which might not be satisfied simultaneously depending on the setting value of another setting item, as the prohibition information. Furthermore, as the resolution information corresponding to such prohibition information, the printer 1 may also perform notification of setting values likely to be satisfied simultaneously regardless of the setting value of the other item.

Specifically, the printer 1 of the present embodiment performs notification of the resolution information as the resolution setting in which “automatic selection” is set for the sheet discharge tray or the sheet feed tray, as depicted in FIG. 4. For example, the setting value “automatic selection” is a setting value which can be replaced, by the printer 1, with a setting value indicating an individual tray. For example, in a case where the printer 1 receives a print job in which the “automatic selection” is set for the item of the sheet feed tray, the printer 1 replaces the setting value for the sheet feed tray with one of three setting values of the standard tray 171, the manual feed tray 172, and the additional tray 173. The process performed by the printer 1 during the printing will be described later on.

In other words, in a case where the “automatic selection” is set for the item of the sheet discharge tray or the item of the sheet feed tray of the print job for which execution instruction has been received, the printer 1 can select a suitable tray among the plurality of trays included in the printer 1, depending on another setting value set in the print job and the situation of the each of the trays, and use the selected tray for the printing.

Next, a specific example of the combination of the prohibition information and the resolution information transmitted by the printer 1 will be described with reference to the prohibition table 24 depicted in FIG. 3 and the resolution table 25 depicted in FIG. 4. In the prohibition table 24 depicted in FIG. 3, the prohibition setting in which the information ID 241 is “1” is a combination of the first setting 243 in which the item of the sheet size has a setting value indicating a size which cannot be discharged to the finisher tray 192, such as an envelope, #10 size, DL size, etc., and the second setting 244 in which the item of the sheet discharge tray has a setting value indicating the finisher tray 192. This combination of the first setting 243 and the second setting 244 is an example of a “first combination”, and is an example of a “first specific combination”.

Then, in a case where the CPU 11 performs notification of the prohibition setting in which the information ID 241 is “1” as the prohibition information, and notification of the resolution setting therefor as resolution information, the CPU 11 performs notification of information in which the resolution name 252 is the same as the resolution name 242, namely, information indicating that the “automatic selection” is set for the sheet discharge tray, based on the resolution table 25 depicted in FIG. 4. The setting value indicating the “automatic selection” in this case is an example of a “first setting value”.

Note that, although FIG. 3 indicates only two to three types of setting values as the first setting 243 and the second setting 244, the printer 1 supports the IPP standard. In a case where a plurality of settings meets the condition(s), the printer 1 performs notification of all the plurality of setting values. For example, as the prohibition setting in which the information ID 241 is “1”, the printer 1 performs notification of each of the setting values of the sheet sizes which cannot be discharged to the finisher tray 192, such as various envelope sizes, as the setting value of the sheet size.

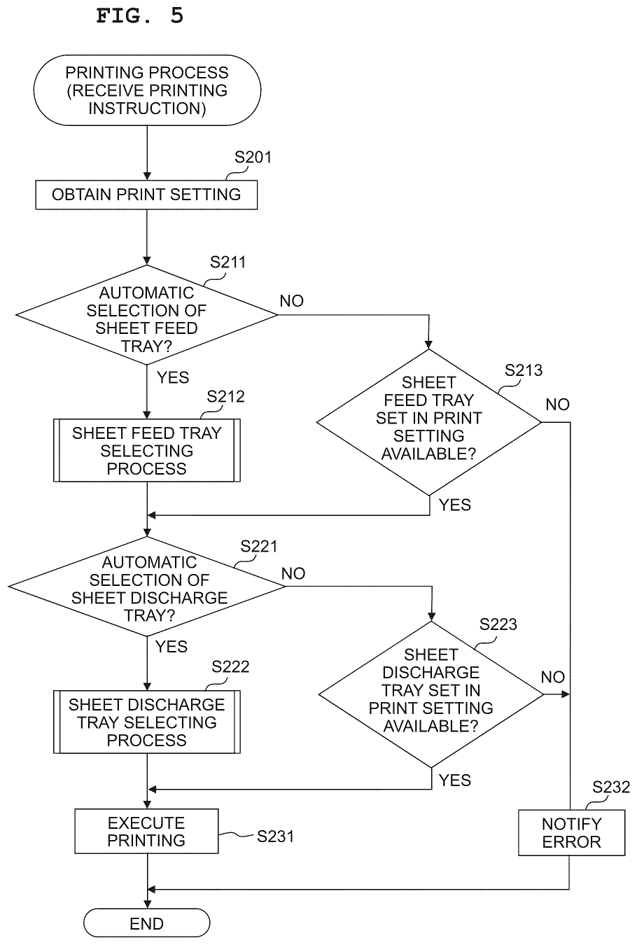

By the notification of the prohibition setting in which the information ID 241 is “1”, the printer 1 might receive, from the terminal device 3, a print job including a print setting in which the envelope is set for the item of the sheet size, and the “automatic selection” is set for the item of the sheet discharge tray. The printer 1 executes the printing based on the received print job and by using the print setting set in the print job. The following description will be made by quoting the reference numerals in FIGS. 5 to 7B, although the details thereof will be described later.

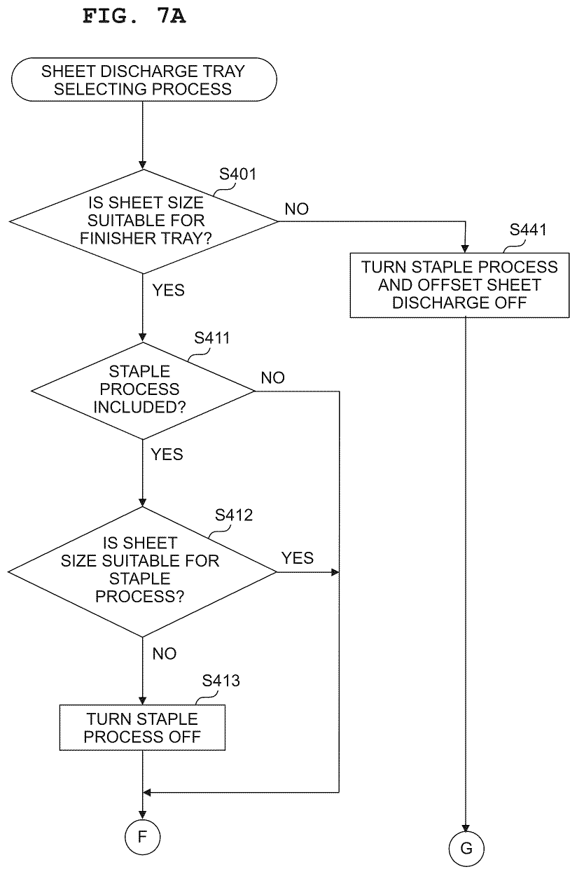

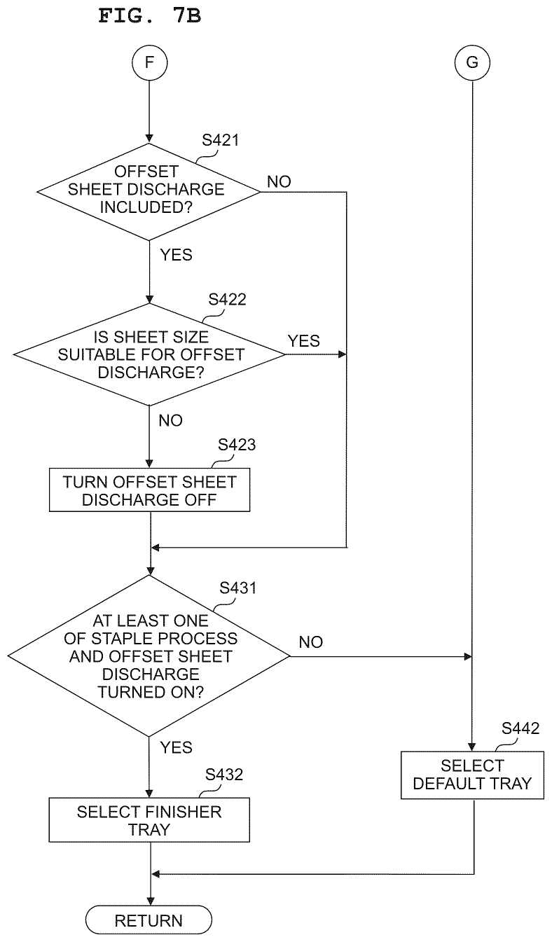

In a case where the printer 1 receives the print job in which the “automatic selection” is set for the sheet discharge tray, the printer 1 determines YES in step S221 of the printing process (FIG. 5), and executes a sheet discharge tray selecting process (FIGS. 7A and 7B). Further, in a case where the setting of the sheet size is a size which cannot be discharged to the finisher tray 192, such as the envelope (NO in step S401 in FIG. 7A), the printer 1 turns a setting of a staple process and a setting of an offset sheet discharge OFF (step S441), selects a default tray as the sheet discharge tray (step S442), and performs the printing. Note that the default tray of the sheet discharge tray is the first tray 181 or the second tray 182, and is not the finisher tray 192.

The printer 1 may include, for example, the second tray 182 by an opening defined in a path via which the sheet after the printing is conveyed to the first tray 181. In this configuration, the sheet after the printing is discharged to the first tray 181 in a case where the opening is closed, and is discharged to the second tray 182 in a case where the opening is open. Further, the first tray 181 and the second tray 182 may be two independent sheet discharge trays. In such a case, the printer 1 selects the first tray 181 in a case where the first tray 181 is set as the default tray, whereas the printer 1 selects the second tray 182 in a case where the second tray 182 is set as the default tray.

In a case where the sheet size which cannot be discharged to the finisher tray 192 is selected, the printer 1 cannot discharge the sheet to the finisher tray 192. By notification of the combination of the setting value indicating the sheet size which cannot be discharged to the finisher tray 192 and the setting value indicating the finisher tray 192 as the sheet discharge tray as the prohibition information, the printer 1 might receive a print job having a print setting in which one of the setting values of this combination is changed. Namely, such a possibility that the printer 1 might receive a print job in which the combination of the setting values that cannot be satisfied at the same time is lowered.

By the notification of the information in which the “automatic selection” is set for the sheet discharge tray as the resolution information for the prohibition information, the printer 1 is highly likely to receive a print job in which the “automatic selection” is set for the sheet discharge tray. In a case where the “automatic selection” is set for the sheet discharge tray, the printer 1 is highly likely to select a suitable sheet discharge tray in accordance with the sheet size and to discharge the sheet appropriately.

Further, in the prohibition table 24 depicted in FIG. 3, the prohibition setting in which the information ID 241 is “2” is a combination of the first setting 243 in which the item of the sheet size has a setting value indicating a size not suitable for the staple process, such the A5 size, the A6 size, the envelope, etc., and the second setting 244 in which the item of the finishing has a setting value indicating the staple process. This combination of the first setting 243 and the second setting 244 is an example of the “first combination”, and is an example of a “second specific combination”. The staple process is a process in which the stapler 191 included in the finisher 19 is used to staple sheets after the printing.

Then, in a case where the CPU 11 performs notification of the prohibition setting in which the information ID 241 is “2” as the prohibition information, and notification of the resolution setting therefor as the resolution information, the CPU 11 performs notification of a resolution setting 253 in which the resolution name 252 is the same as the resolution name 242, namely, information indicating that the “automatic selection” is set for the sheet discharge tray, based on the resolution table 25 depicted in FIG. 4. The setting value indicating the “automatic selection” in this case is an example of a “second setting value”.

Furthermore, in the prohibition table 24 depicted in FIG. 3, the prohibition setting in which the information ID 241 is “3” is a combination of the first setting 243 in which the item of the sheet size has a setting value indicating a size not suitable for an offset sheet discharging process, such the envelope, etc., and the second setting 244 in which the item of the finishing has a setting value indicating the offset sheet discharging process. This combination of the first setting 243 and the second setting 244 is an example of the “first combination”, and is an example of a “third specific combination”. The offset sheet discharging process is a process of moving the finisher tray 192 so as to shift a sheet discharging position of sheets after the printing, by a unit of copy number.

Then, in a case where the CPU 11 performs notification of the prohibition setting in which the information ID 241 is “3” as the prohibition information, and notification of the resolution setting therefor as the resolution information, the CPU 11 performs notification of a resolution setting 253 in which the resolution name 252 is the same as the resolution name 242, namely, information indicating that the “automatic selection” is set for the sheet discharge tray, based on the resolution table 25 depicted in Further. 4. The setting value indicating the “automatic selection” in this case is an example of a “third setting value”.

In a case where the sheet size which is not suitable for the staple process or the offset sheet discharge is selected, the printer 1 cannot execute the staple process or the offset sheet discharge. By notification of the combination of the setting value indicating the sheet size which is not suitable for the staple process or the offset sheet discharge and the setting value indicating the staple process or the offset sheet discharge as the prohibition information, the printer 1 might receive a print job having a print setting in which one of the setting values of this combination is changed. Further, a sheet discharge tray which is to be used is different between a case where the setting value of the sheet size is changed to a setting value suitable to the staple process or the offset sheet discharge and a case where the staple process or the offset sheet discharge is turned OFF without changing the setting value of the sheet size.

By the notification of the information in which the “automatic selection” is set for the sheet discharge tray as the resolution information for the prohibition information, the printer 1 is highly likely to receive a print job in which the “automatic selection” is set for the sheet discharge tray. In a case where the printer 1 receives the print job in which the “automatic selection” is set for the sheet discharge tray, the printer 1 determines YES in step S221 of the printing process (FIG. 5), and executes a sheet discharge tray selecting process (FIGS. 7A and 7B).

Then, in a case where the sheet size is a size suitable for the finisher tray 192 such as A5 size (YES in step S401 in FIG. 7A), the process proceeds to step “S411”. Further, in a case where the sheet size is not suitable for staple process and the offset sheet discharge, the printer 1 determines NO in both step S412 and step S422, and also turns the settings of the staple process and the offset sheet discharge OFF (step S413, step S423). As a result, since the printer 1 determines NO in step S431, the printer 1 selects the default tray as the sheet discharge tray (step S442) and performs the printing.

On the other hand, in a case where the sheet size is a size suitable for the staple process or the offset sheet discharge, the printer 1 determines YES in step S401, and then in a case where the staple process is set, the printer 1 determines YES in step S412, or in a case where the offset sheet discharge is set, the printer 1 then determines YES in step S422. Since the printer 1 determines YES in step S431, the printer 1 selects the finisher tray 192 as the sheet discharge tray. As a result, the printer 1 can perform a finishing process which is set, and discharge the sheet to the finisher tray 192. Therefore, the printer 1 is highly likely to select a suitable sheet discharge tray in accordance with the settings of the sheet size, the staple process, and the offset sheet discharge, and to appropriately discharge the sheets.

Further, in the prohibition table 24 depicted in FIG. 3, the prohibition setting in which the information ID 241 is “4” is a combination of the first setting 243 in which the item of the sheet size has a setting value indicating a small size such as the A6 size, etc., and the second setting 244 in which the item of the sheet feed tray has a setting value indicating the additional tray 173. This combination of the first setting 243 and the second setting 244 is an example of a “second combination”, and is an example of a “fourth specific combination”. Note that the additional tray 173 of the printer 1 is a tray which is disposed below the standard tray 171, and from which sheet of small size cannot be fed. The additional tray is an example of a “specific sheet feed tray”.

Then, in a case where the CPU 11 performs notification of the prohibition setting in which the information ID 241 is “4” as the prohibition information, and notification of the resolution setting therefor as the resolution information, the CPU 11 performs notification of a resolution setting 253 in which the resolution name 252 is the same as the resolution name 242, namely, information indicating that the “automatic selection” is set for the sheet discharge tray, based on the resolution table 25 depicted in FIG. 4. The setting value indicating the “automatic selection” in this case is an example of a “fourth setting value”. By the notification of the resolution information in which the “automatic selection” is set for the sheet discharge tray, the printer 1 is highly likely to receive a print job in which the “automatic selection” is set for the sheet discharge tray.

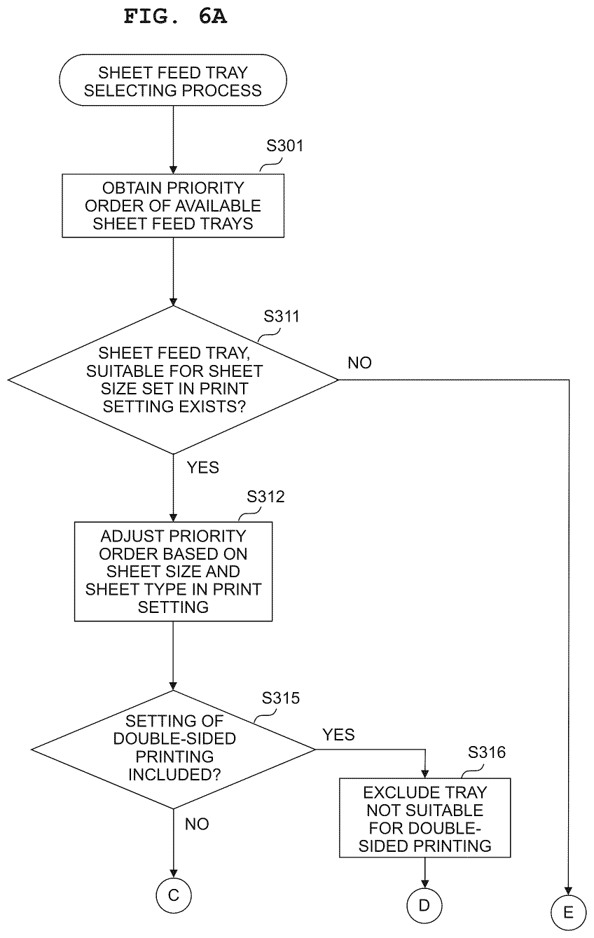

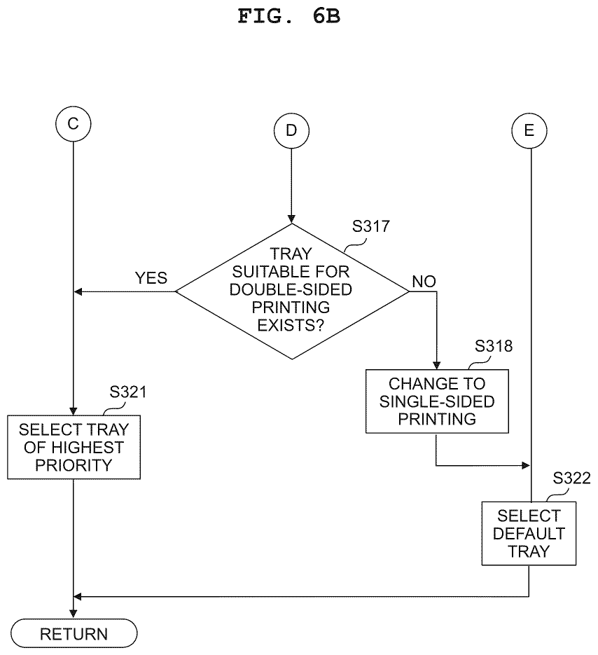

In a case where the printer 1 receives the print job in which the “automatic selection” is set for the sheet discharge tray, the printer 1 determines YES in step S221 of the printing process (FIG. 5), and executes a sheet feed tray selecting process (FIGS. 6A and 6B). In the sheet feed tray selecting process, in a case where the sheet size of the print setting is, for example, the A5 size, the sheet can be fed from the standard tray 171 or the manual feed tray 172, even though the sheet cannot be fed from the additional tray 173. Since the printer 1 determines YES in step S311, the printer 1 may select a sheet feed tray of the highest priority (step S321) based on the priority order and/or a double-sided print setting and may perform the printing. Namely, in a case where the “automatic selection” is set for the sheet feed tray, the printer 1 is highly likely to select a suitable sheet discharge tray in accordance with the sheet size and to appropriately feed the sheet.

Further, in the prohibition table 24 depicted in FIG. 3, the prohibition setting in which the information ID 241 is “5” is a combination of the first setting 243 in which the item of the sheet type has a setting value indicating a special sheet such as a thick sheet, etc., and the second setting 244 in which the sheet discharge tray has a setting value indicating each of the sheet feed trays which is other than the manual feed tray 172.

Then, in a case where the CPU 11 performs notification of the prohibition setting in which the information ID 241 is “5” as the prohibition information, and notification of the resolution setting therefor as the resolution information, the CPU 11 performs notification of a resolution setting 253 in which the resolution name 252 is the same as the resolution name 242, namely, information indicating that the “manual feed tray” is set for the sheet feed tray, based on the resolution table 25 depicted in FIG. 4. Even in a case where the sheet type is the special sheet, the printer 1 can appropriately feed the sheet in a case where the “manual feed tray” is set for the sheet feed tray.

Furthermore, in the prohibition table 24 depicted in FIG. 3, the prohibition setting in which the information ID 241 is “7” is a combination of the first setting 243 in which the item of the sheet size has a setting value indicating a special size such as the envelope, etc., and the second setting 244 in which the sheet discharge tray has a setting value indicating the standard tray 171. This combination of the first setting 243 and the second setting 244 is an example of the “second combination”. Note that the standard tray 171 of the printer 1 is a tray from which the sheet of the special size cannot be fed.

Then, in a case where the CPU 11 performs notification of the prohibition setting in which the information ID 241 is “7” as the prohibition information, and notification of the resolution setting therefor as the resolution information, the CPU 11 performs notification of a resolution setting 253 in which the resolution name 252 is the same as the resolution name 242, namely, notification of information indicating that the “automatic selection” is set for the sheet feed tray, based on the resolution table 25 depicted in FIG. 4.

By the notification of the resolution information in which the “automatic selection” is set for the sheet feed tray, the printer 1 is highly likely to receive a print job in which the “automatic selection” is set for the sheet feed tray. In a case where the printer 1 receives the print job in which the “automatic selection” is set for the sheet feed tray, the printer 1 determines YES in step S211 of the printing process (FIG. 5), and executes the sheet feed tray selecting process (FIGS. 6A and 6B). In the sheet feed tray selecting process, in a case where the sheet size of the print setting is the special size, and where, for example, the sheet can be fed from the manual feed tray 172, the printer 1 determines YES in step S311. Accordingly, the printer 1 may select a sheet feed tray of the highest priority (step S321) based on the priority order and/or the double-sided print setting and may perform the printing. Namely, in a case where the “automatic selection” is set for the sheet feed tray, the printer 1 is highly likely to select a suitable sheet feed tray and appropriately feed the sheet, even in a case where the sheet is of the special size.

Further, in the prohibition table 24 depicted in FIG. 3, the prohibition setting in which the information ID 241 is “8” is a combination of the first setting 243 in which the item of the finishing has a setting value indicating the staple process, and the second setting 244 in which the item of the sheet discharge tray has a setting value indicating each of the sheet discharge trays other than the finisher tray 192. This combination of the first setting 243 and the second setting 244 is an example of the “first combination”, and is an example of a “fifth specific combination”. The staple process is an example of a “specific process”, and the finisher tray is an example of a “specific sheet discharge tray”.

Further, in the prohibition table 24 depicted in FIG. 3, the prohibition setting in which the information ID 241 is “9” is a combination of the first setting 243 in which the item of the finishing has a setting value indicating the offset sheet discharge, and the second setting 244 in which the item of the sheet feed tray has a setting value indicating each of the sheet discharge trays other than the finisher tray 192. This combination of the first setting 243 and the second setting 244 is an example of the “first combination”, and is an example of the “fifth specific combination”. The offset sheet discharge is an example of the “specific process”, and the finisher tray 192 is an example of the “specific sheet discharge tray”.

Then, in a case where the CPU 11 performs notification of the prohibition setting in which the information ID 241 is “8” or “9” as the prohibition information, and notification of the resolution setting therefor as the resolution information, the CPU 11 performs notification of a resolution setting 253 in which the resolution name 252 is the same as the resolution name 242, namely, notification of information indicating the “automatic selection” is set for the sheet discharge tray, based on the resolution table 25 depicted in FIG. 4. The setting value indicating the “automatic selection” in this case is an example of a “fifth setting value”.

The printer 1 of the present embodiment performs notification, as the prohibition information, of the combination of the setting in which the staple process or the offset sheet discharge is set as the setting of finishing, and the sheet discharge tray is different from the finisher tray 192, and the printer 1 performs notification of the information in which the “automatic selection” is set for the sheet discharge tray, as the resolution information for the prohibition information. With this, the printer 1 is highly likely to receive a print job in which the “automatic selection” is set for the sheet discharge tray, regardless of the presence or absence of the setting of the finishing. In a case where the printer 1 receives the print job in which the “automatic selection” is set for the sheet discharge tray, the printer 1 executes the sheet discharge tray selecting process as described above, and can select a suitable sheet discharge tray based on the setting of the sheet size and the setting of the finishing.

Note that even in a case where the printer 1 does not perform the finishing process for the sheet after the printing, the printer 1 can discharge the sheet to the finisher tray 192. Further, in a case where the printer 1 is configured not to execute the staple process or the offset sheet discharge, for example, in a case where the finisher 19 is not attached to the printer 1, the printer 1 determines NO in step S104 of the prohibition notifying process. Accordingly, the CPU 11 does not perform notification of the combinations in each of which the information ID 241 is “2”, “3”, “8”, or “9” as the prohibition information.

Furthermore, in the resolution table 25 depicted in FIG. 4, the different resolution names 252 are provided even for each of same resolution settings, and a record is stored for each of the different resolution names 252. However, the same resolution name 252 may be assigned to the same resolution settings and may be stored as a single record. For example, a resolution setting in which the “automatic selection” is set for the sheet discharge tray may be one record of the resolution name 252 of “discharge tray: automatic selection”, and the resolution names 242, in the prohibition table 24 depicted in FIG. 3, in each of which the information ID 241 corresponds to one of the prohibition settings “1” to “3” may be set as the “discharge tray: automatic selection”.

In such a manner, there are a plurality of combinations of the prohibition settings transmitted by the printer 1, and the printer 1 can perform notification of the resolution information regarding the setting items which differ for each of the combinations. In other words, the printer 1 can perform notification of the information, as the resolution information, indicating the “automatic selection” for both the item of the sheet discharge tray and the item of the sheet feed tray. The item of the sheet discharge tray and the item of the sheet feed tray are each an example of the “predetermined setting item”, and are examples, respectively, of a “first setting item” and a “second setting item”. The setting values indicating the “automatic selection” set, respectively, for the item of the sheet discharge tray and the item of the sheet feed tray are each an example of the “specific setting value”, and are examples, respectively, of a “first specific setting value” and a “second specific setting value”. Since the setting value indicating the “automatic selection” for the plurality of setting items can be transmitted, the degree of freedom in the setting values which are to be solved is increased. This increases a possibility that a plurality of prohibition settings might also be resolved flexibly.

Next, the procedure of the printing process executed by the printer 1 will be described with reference to the flowchart of FIG. 5. The CPU 11 of the printer 1 executes the printing process based on the IPP print program 22, upon receiving a printing instruction for a print job based on the IPP standard, from the external device such as the terminal device 3.

For example, by executing the IPP client application 31, the terminal device 3 can transmit the request for the response information to the printer 1 and receive the information notified from the printer 1, as described above. After receiving the information transmitted from the printer 1, the terminal device 3 can transmit the print job to the printer 1.

The CPU 11 obtains the print setting of the received print job (step S201). The print setting includes a plurality of items. In step S201, the CPU 11 obtains the specified setting values for all the items set in the print job to be executed. Note that in a case where the print setting obtained in step S201 includes a print setting which cannot be executed by the printer 1, the CPU 11 may perform notification of an error and not perform the printing. For example, in a case where the print setting includes the execution of the staple process and the finisher 19 is not attached to the printer 1, or in a case where the stapler 191 is not built into the finisher 19 of the printer 1, the CPU 11 may perform notification of an error.

The CPU 11 determines whether the “automatic selection” is set for the item of the sheet feed tray of the print setting (step S211). In a case where the CPU 11 determines that the “automatic selection” is set for the item of the sheet feed tray (step S211: YES), the CPU 11 executes the sheet feed tray selecting process (step S212).

The procedure of the sheet feed tray selecting process will be described with reference to the flowchart of FIGS. 6A and 6B. The CPU 11 obtains information on a sheet feed tray which can be used and information on the priority order which is set (step S301). Note that the printer 1 stores the information of the priority order in the memory 12. The printer 1 can receive the specification of the priority order of the sheet feed trays through an operation by a user, for example, on the operation panel 13, and can store information on the received priority order in the memory 12. In step S301, the CPU 11 sorts the sheet feed trays which can be used based on the priority order and generates a temporary list. Note that the CPU 11 may exclude, for example, a sheet feed tray which does not accommodate the sheet(s) or a sheet feed tray which is not permitted to be used, from the list.

The CPU 11 determines whether a sheet feed tray, which is suitable for the sheet size set in the print setting, exists among the sheet feed trays which are determined to be usable in step S301 (step S311). In a case where the CPU 11 determines that the sheet feed tray, which is suitable for the sheet size, exists (step S311: YES), the CPU 11 adjusts the priority order of the list generated in step S301, based on the sheet size and the sheet type in the print setting (step S312). Specifically, the CPU 11 prioritizes the sheet feed trays in such an order that the highest priority is given to a sheet feed tray of which sheet size and sheet type both match the print setting, the second priority is given to a sheet feed tray of which sheet size only matches the print setting, the third priority is given to a sheet feed tray of which sheet type only matches the print setting, and the fourth priority is given to a sheet feed tray of which sheet size and sheet type both do not match the print setting.

Further, the CPU 11 determines whether the double-sided printing is set in the print setting (step S315). In a case where the CPU 11 determines that double-sided printing is set (step S315: YES), the CPU 11 excludes the sheet feed tray(s), with which the double-sided printing cannot be executed, from the list which has been already adjusted in step S312 (step S316). After step S316, the CPU 11 determines whether a compatible sheet feed tray remains in the list of the sheet feed trays (step S317).

In a case where the CPU 11 determines that a compatible sheet feed tray remains (step S317: YES), or in a case where the CPU 11 determines that double-sided printing is not set (step S315: NO), the CPU 11 selects the sheet tray of the highest priority, based on the priority order of the list, as the sheet feed tray to be used (step S321). That is, the CPU 11 replaces the setting value of the item of the sheet feed tray of the print job, with a setting value indicating the sheet feed tray selected in step S321.

On the other hand, in a case where the CPU 11 determines that no compatible sheet feed tray remains during step S316 (step S317: NO), the CPU 11 changes the setting of the double-sided printing in the print setting to the single-sided printing (step S318). In a case where no sheet feed tray, which is suitable for the double-sided printing, exists, the printer 1 does not perform the double-sided printing, thereby reducing such a possibility that printing cannot be performed.

After step S318, or in a case where the CPU 11 determines that no sheet feed tray, which is suitable for the sheet size specified in the print setting, exists (step S311: NO), the CPU 11 selects a sheet feed tray set as the default in the printer 1, as the sheet feed tray to be used (step S322). After step S321 or step S322, the CPU 11 ends the sheet feed tray selecting process and returns to the printing process.

Note that the printer 1 may give priority to performing the printing and may use, for example, sheet which is different from that of the print setting of the print job. For example, in step S312 of the sheet feed tray selecting process, the CPU 11 preferentially selects a sheet feed tray that accommodates sheet(s) of which size and/or type matches the sheet size and/or the sheet type set in the print setting. However, in a case where no compatible sheet feed tray exists, the CPU 11 may select, in step S321 or step S322, a sheet feed tray that accommodates sheet(s) of which size and/or type is different from the sheet size and/or the sheet type set in the print setting.

In a case where a sheet tray that accommodates sheet(S) of a size and/or type different from the sheet size and/or the sheet type specified in the print setting is selected in the sheet tray selecting process, the CPU 11 changes the sheet size and/or the sheet type specified in the print setting in conformity with the sheet feed tray selected in the sheet feed tray selecting process, and performs subsequent processes. For example, in a case where the sheet size specified in the print setting is the A5 size, no sheet tray accommodating the sheet of A5 size exists, and a sheet feed tray accommodating the sheet of A4 size is selected, the CPU 11 changes the setting value of the sheet size to the A4 size and performs the subsequent processes.

Further, in step S321 or step S322, in a case where no sheet feed tray accommodating sheets suitable for the print setting exists, the printer 1 may perform the error notification and may not perform the printing. Alternatively, the printer 1 may perform notification of information indicating that no sheet which is suitable for the print setting exists and that the print setting is changed to perform the printing. Further, the printer 1 may ask the user whether the print setting is to be changed so as to perform the printing, via the operation panel 13, and may perform the printing in a case where the printer 1 receives an instruction to print from the user.

Returning to the description of the printing process in FIG. 5, in a case where the CPU 11 determines that the “automatic selection” is not set for the item of the sheet feed tray (step S211: NO), the CPU 11 determines whether the sheet feed tray set in the print setting can be used (step S213). The expression “the setting value of the item of the sheet feed tray is not set to the automatic selection” means that a specific sheet feed tray is specified as the sheet feed tray to be used for the print setting. Therefore, the CPU 11 obtains the state of the sheet feed tray specified in the print setting, and in a case where the specified sheet feed tray can be used, the CPU 11 selects the sheet feed tray specified in the print setting as the sheet feed tray to be used.

Note that in step S213, the CPU 11 may not process items other than the item of the sheet feed tray in the print setting. For example, in a case where the specified sheet feed tray can be used regardless of the sheet size and/or the sheet type of the print setting, the CPU 11 may select the specified sheet feed tray. Alternatively, the CPU 11 may perform error notification in a case where the sheet size and/or the sheet type of the sheet accommodated in the specified sheet feed tray do not match the sheet size and/or the sheet type specified in the print setting

After the sheet feed tray selecting process in step S212 or in a case where the CPU 11 determines that the sheet feed tray set in the print setting can be used (step S213: YES), the CPU 11 determines whether the “automatic selection” is set for the item of the sheet discharge tray in the print setting (step S221). In a case where the CPU 11 determines that the “automatic selection” is set for the item of the sheet discharge tray (step S221: YES), the CPU 11 executes the sheet discharge tray selecting process (step S222).

The procedure of the sheet discharge tray selecting process will be described with reference to the flowchart of FIGS. 7A and 7B. The CPU 11 determines whether the sheet size of a sheet to be printed is the sheet size that can be discharged to the finisher tray 192 (step S401). The CPU 11 makes the determination in step S401, for example, based on the sheet size specified in the print job and the sheet size of the sheet accommodated in the sheet feed tray selected in the sheet feed tray selecting process.

In a case where the CPU 11 determines that the sheet size is such a sheet size that can be discharged to the finisher tray 192 (step S401: YES), the CPU 11 determines whether the print setting includes a setting indicating that the staple process is to be performed (step S411).

In a case where the CPU 11 determines that the setting for performing the staple process is included (step S411: YES), the CPU 11 determines whether the sheet size is a sheet size for which the staple process can be performed (step S412). In a case where the CPU 11 determines that the sheet size is not the sheet size for which the staple process can be performed (step S412: NO), the CPU 11 turns the staple process OFF (step S413). In other words, the CPU 11 applies the setting value of the sheet size in preference to the staple process. Note that the CPU 11 may notify the user that the staple process will not be performed.

After step S413, or in a case where the CPU 11 determines that the setting of executing the staple process is not included (step S411: NO), or in a case where the CPU 11 determines that the sheet size is a sheet size for which the staple process can be performed (step S412: YES), the CPU 11 determines whether the print setting includes the setting indicating that the offset sheet discharge process is to be performed (step S421).

In a case where the CPU 11 determines that the print setting includes the setting for performing the offset sheet discharge process (step S421: YES), the CPU 11 determines whether the sheet size is a sheet size which is suitable for the offset sheet discharging process (step S422). In a case where the CPU 11 determines that the sheet size is not suitable for the offset sheet discharging process (step S422: NO), the CPU 11 turns the offset sheet discharging process OFF (step S423). In other words, the CPU 11 applies the setting value of the sheet size in preference to the offset sheet discharging process. Note that the CPU 11 may perform notification indicating that the offset sheet discharging process will not be performed.

After step S423, or in a case where the CPU 11 determines that the print setting does not include the setting for performing the offset sheet discharging process (step S421: NO), or in a case where the CPU 11 determines that the sheet size is a sheet size which is suitable for the offset sheet discharging process (S422: YES), the CPU 11 determines whether at least one of the staple process and the offset sheet discharging process is on (step S431).

In a case where the CPU 11 determines that at least one of the staple process and the offset sheet discharging process is turned ON (step S431: YES), the CPU 11 selects the finisher tray 192 as the sheet discharge tray (step S432).

On the other hand, in a case where the CPU 11 determines that the sheet size of a sheet to be printed is not the sheet size that can be discharged to the finisher tray 192 (step S401: NO), the CPU 11 turns the staple process and the offset sheet discharging process OFF (step S441). After step S441, or in a case where the CPU 11 determines that both the staple process and the offset sheet discharging process are turned OFF (step S431: NO), the CPU 11 selects the sheet discharge tray set as the default in the printer 1, as a sheet discharge tray to be used for the printing (step S442).

The CPU 11 replaces the setting value of the item of the sheet discharge tray of the print job with the setting value indicating the sheet discharge tray selected in step S432 or step S442. After step S432 or step S442, the CPU 11 ends the sheet discharge tray selecting process and returns to the printing process.

Returning to the description of the printing process in FIG. 5, in a case where the CPU 11 determines that the “automatic selection” is not set for the item of the sheet discharge tray (step S221: NO), the CPU 11 determines whether the sheet discharge tray set in the print setting can be used (step S223). The expression “the setting value of the item of the sheet discharge tray is not set to the automatic selection” means the specific sheet discharge tray is specified in the print setting as the sheet discharge tray to be used. Therefore, the CPU 11 obtains the state of the sheet discharge tray specified in the print setting, and in a case where the specified sheet discharge tray can be used, the CPU 11 selects the sheet discharge tray specified in the print setting as the sheet discharge tray to be used.

After the sheet discharge tray selecting process in step S222, or in a case where the CPU 11 determines that the sheet discharge tray set in the print setting can be used (step S223: YES), the CPU 11 causes the print engine 15 to execute the printing (step S231). The CPU 11 feeds a sheet from the selected sheet feed tray, and discharges the sheet after printing by the print engine 15 to the selected sheet discharge tray. In a case where the staple process or the offset sheet discharging process is turned ON, the CPU 11 executes the staple process or the offset sheet discharging process, and discharges the sheet to the finisher tray 192.

On the other hand, in a case where the CPU 11 determines that the sheet feed tray is not set to the “automatic selection” and the sheet feed tray set in the print setting cannot be used (step S213: NO), or the CPU 11 determines that the sheet feed tray is not set to the “automatic selection” and the sheet discharge tray set in the print setting cannot be used (step S223: NO), the CPU 11 performs an error notification and does not execute the printing (step S232). For example, in a case where the sheet is not accommodated in the specified sheet feed tray or in a case where the specified sheet discharge tray is full, the CPU 11 will not execute the printing until the situation is improved. After step S231 or step S232, the CPU 11 ends the printing process.

As described in detail in the foregoing, the printer 1 of the present embodiment is capable of making a response with the prohibition information which is the combination of the setting values which should not be associated at the same time, and the resolution information resolving the prohibition information, in response to the request for the response information from the terminal device 3. Further, the printer 1 may perform notification of the setting value indicating the “automatic selection” in the item of the sheet feed tray or the item of the sheet discharge tray, as the resolution information, in some cases. The setting value indicating the “automatic selection” is the setting value indicating that the setting value indicating the sheet feed tray or the sheet discharge tray is replaceable by the printer 1 with a setting value indicating an individual tray. Furthermore, after the printer 1 has transmitted the setting value indicating the “automatic selection” in the item of the sheet feed tray or the item of the sheet discharge tray, in a case where the printer 1 receives, from the terminal device 3, the print job in which the setting value indicating the “automatic selection” is set for the item of the sheet feed tray or the item of the sheet discharge tray, the printer 1 performs the printing by selecting a sheet feed tray and/or a sheet discharge tray suitable for a situation in which the printing based on the print job is executed, among the trays each of which is selectable as the sheet feed tray or the sheet discharge tray. Accordingly, even with respect to the printing without using the printer driver, the printer 1 is highly likely to resolve prohibition setting flexibly.

Note that the present embodiment is merely an example, and does not limit the present disclosure in any way. Therefore, it goes without saying that various improvements and/or modifications can be made to the present disclosure without departing from the spirit thereof. For example, the printer 1 is not limited to an apparatus exclusive for printing, and may also be a multifunction peripheral, a copying machine, a fax machine, etc. Further, the printing system of the printer 1 may be the thermal transfer system, the thermal system, or the like.

Further, in the embodiment, although the printer 1 is described as configured to have three sheet feed trays and three sheet discharge trays, the number of these trays is not limited to this. Note that, however, in order that the notification of the setting value indicating the “automatic selection” as the resolution information takes effect, the printer 1 preferably has the plurality of sheet feed trays and the plurality of sheet discharge trays.

Further, although the embodiment describes the example in which the setting value indicating the “automatic selection” is transmitted as the resolution information, the resolution information to be transmitted may be a setting value indicating that a tray is to be selected in the printer 1; the setting value does not necessarily have to be the setting value indicating the “automatic selection”. For example, the setting value may be a setting value indicating a tray which cannot be included in the printer 1.

Further, in the embodiment, although the printer 1 is configured to respond to the request for information in accordance with the IPP standard, the standard adopted in the printer 1 may not be the IPP standard. The printer 1 may make a response to a request in accordance with, for example, a standard defined by the OS of the terminal device, a standard defined by the vendor of the printer 1, or a standard defined by a platform on the Internet.

Furthermore, in the embodiment, the printer 1 is configured to receive the request for the resolution information together with the request for the prohibition information. The printer 1, however, may be configured to receive only the request for the resolution information. The printer 1 may also be configured to receive one request which serves as both the request for the prohibition information and the request for the resolution information. In a case where the printer 1 receives the one request which serves as both the request for the prohibition information and the request for the resolution information, the printer 1 may be configured to make a response by combining the prohibition information and the resolution information, in response to the one request. In such a case, the printer 1 may be configured to make a response by combining the prohibition information and the resolution information, in response to the request. Moreover, for example, such a request may be provided wherein, as the prohibition information, information on the combinations of the setting values which cannot be satisfied at the same time is distinguished from information on a combination of setting values which might not be satisfied at the same time depending on a setting value of another item. In such a case, the printer 1 may be configured to make a response by distinguishing each piece of the prohibition information in response to the received request.

Further, for example, the printer 1 may previously have information on a tray set as a default tray and/or information on the priority orders of trays, or the printer can be configured to receive the above-described information based on an operation of the user.

The printer of the present embodiment may be configured to perform printing based on a print job received from an external device, in accordance with a plurality of setting values associated with the received print job, wherein the printer may be configured to: notify the external device of resolution information in response to a first request from the external device, the resolution information being information to resolve a combination of setting values not to be associated with each other at a same time, the resolution information being information in which a specific setting value is set for a predetermined setting item, the specific setting value indicating that the printer replaces the specific setting value with another setting value; select one setting value in accordance with a situation of the printer from a plurality of setting values with which the specific setting value is replaceable, in a case where the printer has notified the external device of the resolution information in response to the first request from the external device and then the printer receives a print job associated with the specific setting value from the external device; and perform the printing based on the print job in accordance with the one setting value that has been selected.

In the printer of the present embodiment, the specific setting value may include a first specific setting value corresponding to a first setting item and a second specific setting value corresponding to a second setting item, the first specific setting value may be replaceable with one of a plurality of first setting values and the second specific setting value may be replaceable with one of a plurality of second setting values, and in a case where the printer has notified the external device of the resolution information in response to the first request from the external device and then the printer receives the print job associated with at least one of the first specific setting value and the second specific setting value from the external device, the printer may be configured to: select one setting value in accordance with the situation of the printer from the plurality of first setting values with which the first specific setting value is replaceable, in a case where the received print job is associated with the first specific setting value; select one setting value in accordance with the situation of the printer from the plurality of second setting values with which the second specific setting value is replaceable, in a case where the received print job is associated with the second specific setting value; and perform the printing based on the print job in accordance with the one setting value which has been selected.

In the printer of the present embodiment, the combination of the setting values not to be associated with each other at the same time may include a first combination and a second combination, and in response to the first request from the external device, the printer may be configured to: notify the external device of the resolution information in which the first setting item has the first specific setting value, as the resolution information for the first combination; and notify the external device of the resolution information in which the second setting item has the second specific setting value, as the resolution information for the second combination.

In the printer of the present embodiment, in a case where the printer receives a second request from the external device, the printer may be configured to notify the external device of prohibition information indicating the combination of the setting values not to be associated with each other at the same time, the first combination and first identification information being associated with each other in the prohibition information, the second combination and second identification information being associated with each other in the prohibition information, and in response to the first request from the external device, the printer may further be configured to: notify the external device of the resolution information in which the first specific setting value is set for the first setting item, as the resolution information for the first combination, while associating the resolution information with the first identification information; and notify the external device of the resolution information in which the second specific setting value is set for the second setting item, as the resolution information for the second combination, while associating the resolution information with the second identification information.

In the printer of the present embodiment, in a case where the printer receives the “job-resolvers-supported” command as the first request from the external device in accordance with an Internal Printing Protocol standard, the printer may be configured to notify the external device of the resolution information.

In the printer of the present embodiment, the combination of the setting values not to be associated with each other at the same time may include a first specific combination in which a size unsuitable for a specific sheet discharge tray is set for a sheet size and the specific sheet discharge tray is set for a sheet discharge tray, and in response to the first request from the external device, the printer may be configured to notify the external device of the resolution information, in which the predetermined setting item is the sheet discharge tray and one of the plurality of first setting values is set for the sheet discharge tray as the specific setting value, as the resolution information resolving the first specific combination.

In the printer of the present embodiment, the combination of the setting values not to be associated with each other at the same time may include a second specific combination in which a size unsuitable for a staple process is set for a sheet size and an execution of the staple process is included, the staple process being a process for stapling sheets after the printing, and in response to the first request from the external device, the printer may be configured to notify the external device of the resolution information, in which the predetermined setting item is the sheet discharge tray and one of the plurality of second setting value is set for the sheet discharge tray as the specific setting value, as the resolution information resolving the second specific combination.

In the printer of the present embodiment, the combination of the setting values not to be associated with each other at the same time may include a third specific combination in which a size unsuitable for an offset sheet discharging process is set for a sheet size and execution of the offset sheet discharging process is included, the offset sheet discharging process being a process for shifting a discharging position of sheets after the printing by the number of copies, and in response to the first request from the external device, the printer may be configured to notify the external device of the resolution information, in which the predetermined setting item is the sheet discharge tray and a third setting value is set for the sheet discharge tray as the specific setting value, as the resolution information resolving the third specific combination.

In the printer of the present embodiment, the combination of the setting values not to be associated with each other at the same time may include a fourth specific combination in which a size unsuitable for a specific sheet feed tray is set for a sheet size and the specific sheet feed tray is set for a sheet feed tray, and in response to the first request from the external device, the printer may be configured to notify the external device of the resolution information, in which the predetermined setting item is the sheet feed tray and a fourth setting value is set for the sheet feed tray as the specific setting value, as the resolution information resolving the fourth specific combination.

In the printer of the present embodiment, the combination of the setting values not to be associated with each other at the same time may include a fifth specific combination, in which a setting of performing a specific process required to use a specific sheet discharge tray is included and a discharge tray other than the specific sheet discharge tray is set for the sheet discharge tray, and in response to the first request from the external device, the printer may be configured to notify the external device of the resolution information, in which the predetermined setting item is the sheet discharge tray and a fifth setting value is set for the sheet discharge tray as the specific setting value, as the resolution information resolving the fifth specific combination.

### Second Embodiment

Conventionally, a procedure has been disclosed in which a printer transmits its state by a message composed in natural language to an IPP client, which is configured to generate a print job in accordance with the IPP standard. However, the manner of generating the message is entrusted to the printer. Accordingly, the procedure for generating the message in the printer can be improved further.

In the following, a second embodiment configured to solve the above-described problem will be described in detail with reference to the accompanying drawings. Similarly to the first embodiment, a printer 1 of the second embodiment also can execute printing based on a printing instruction according to the IPP standard and has the configuration as depicted in FIG. 1. Note that the printer 1 of the second embodiment includes a print engine 15 of which its printing system is, for example, the electrophotographic system. The print engine 15 is capable of performing color printing with a plurality of toners of mutually different colors. Each toner is an example of a colorant. Further, in the printer 1 of the second embodiment, the notification information 23 may not include the prohibition table 24 and the resolution table 25.

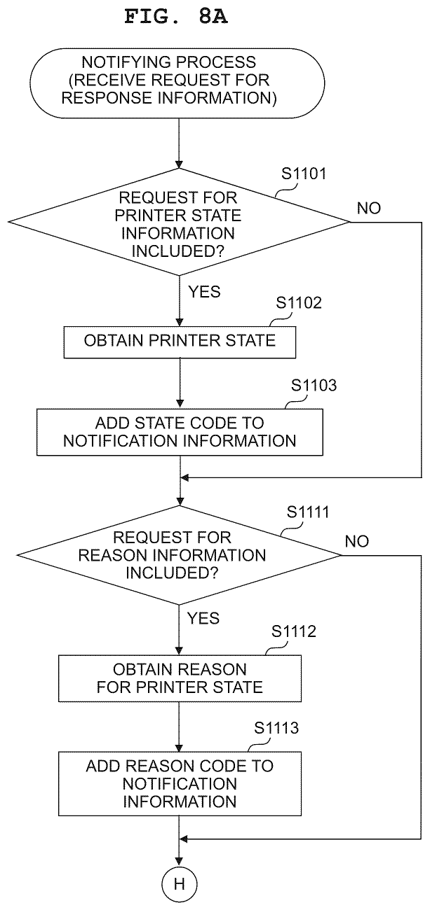

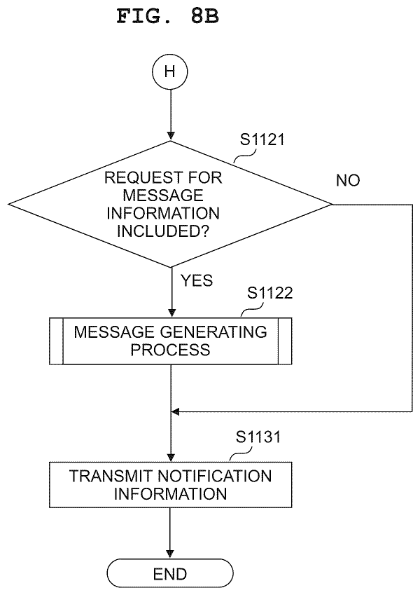

The procedure of a notifying process executed by the printer 1 of the second embodiment will be described with reference to the flowchart of FIGS. 8A and 8B. The CPU 11 of the printer 1 executes the notifying process based on the IPP response program 21 upon receiving a request for response information from an external device such as the terminal device 3.

Note that the IPP client application 31 has a function of communicating with the printer 1, which is a device caused by the IPP client application 31 to execute the printing, and requesting the printer 1 to transmit information. In some cases, the IPP client application 31 requests the printer 1, which is to be caused to execute the printing by the IPP client application 31, to transmit the information, for example, at a timing before transmission of a printing instruction, and executes a process for generating a print job by using the information transmitted thereto as a response. For example, in a case where the printer 1 receives the request for the response information from the terminal device 3, the printer 1 can generate the requested information based on a command included in the request for the response information and respond to the terminal device 3.

The CPU 11 determines whether the received request for the response information includes a request for printer state information (step S1101). The printer state information is information indicating the current state of the printer 1. The printer 1 has at least three states, for example, the printer is “stopped”, “idle”, and “processing. The request for the printer state information is an example of a “first request”. A request for the printer state information based on the IPP standard is, for example, a “printer-state” command.

In a case where the CPU 11 determines that the request for the printer state information is included (step S1101: YES), the CPU 11 obtains the state of the printer 1 (step S1102). Further, the CPU 11 adds a state code, which is information indicating the obtained state of the printer 1, to notification information (step S1103). The state code is information defined for each state of the printer 1 based on the IPP standard to which the terminal device 3 conforms. The notification information is information which is responded to the terminal device 3 in a procedure described later. Note that at the start of the notifying process, the notification information does not include any information.

After step S1103, or in a case where the CPU 11 determines that the received request for the response information does not include the request for the printer state information (step S1101: NO), the CPU 11 determines whether the received request for the response information includes a request for printer state reason information (step S1111). The printer state reason information is information indicating the reason for the printer 1 to be in the current state. The reason for the printer state includes various reasons, the number of which is greater than the number of the states for the printer. For example, the reason for the printer to be in the “stopped” state includes many reasons such as “cover open”, “no tonner”, “photoconductor needs to be replaced”, and so on. The request for the printer state reason information is an example of a “second request”. The request for the printer state reason information based on the IPP standard is, for example, a “printer-state-reasons” command.

In a case where the CPU 11 determines that the received request for the response information includes the request for the printer state reason information (step S1111: YES), the CPU 11 obtains the reason for the printer 1 to be in the state (step S1112). Note that in a case where the reason for the state of the printer 1 has been obtained in step S1102, the CPU 11 may skip step S1112. Furthermore, the CPU 11 adds a reason code, which is information indicating the reason for the printer 1 to be in the state, to the notification information (step S1113). The reason code is information defined for each reason for the state of the printer 1 based on the IPP standard to which the terminal device 3 conforms.

Note that depending on the state of the printer 1, the reason for the state of the printer 1 might include a plurality of reasons, in some cases. For example, in a case where the printer 1 is stopped and the reason therefor corresponds to both of the “cover open” and the “no toner”, the CPU 11 obtains all of the plurality of reasons in step S1112. Then, the CPU 11 adds all of a plurality of reason codes, which correspond to the plurality of obtained reasons, respectively, to the notification information.

Further, depending on the state of the printer 1, no reason might exist for the state. For example, in a case where the printer 1 is idle, no particular reason for which the printer 1 is idle exists, and no reason for the printer 1 to be in this idling state exists. In a case where the CPU 11 is unable to obtain the reason in step S1112, that is, in a case where no reason exists, the CPU 11 adds a reason code indicating “none” to the notification information in step S1113. The reason code indicating “none” is a reason code indicating that no reason exists, and is an example of a “special code”.

Furthermore, in a case where no reason code corresponding to the reason obtained in step S1112 exists, for example, in a case where a reason code is not defined based on the IPP standard, the CPU 11 adds a reason code indicating “other” to the notification information in step S1113. The reason code indicating “other” is a reason code indicating that no reason code corresponding to the reason exists, and is an example of the “special code”.

After step S1113, or in a case where the CPU 11 determines that the received request for the response information does not include the request for the printer state reason information (step S1111: NO), the CPU 11 determines whether a request for printer state message information is included in the received request for the response information (step S1121). The printer state message information is a message expressing the current state of the printer 1 and the reason for that state in natural language. The request for the printer state message information is an example of a “third request”. The request for the printer state message information based on the IPP standard is, for example, a “printer-state-message” command. Note that in the present specification, a message in the English language is exemplified as the message in the natural language.

Although the state code added in step S1103 and the reason code added in step S1113 are previously determined based on the IPP standard, the printer state message information requested in step S1121 is not determined based on the IPP standard. A vendor of the printer is capable of freely preparing the printer state message information for the response. Therefore, the degree of freedom of messages is high. However, the printer 1 prepares one message for one reason code as the message information for the response to a request based on the IPP standard. Therefore, the printer 1 responds to the request with message information previously determined for each of reason codes. The printer 1 does not make a response with respect to one reason code, with a dynamic message, such as a message which varies depending on the state of the printer 1, as the message information.

In a case where the CPU 11 determines that the received request for the response information includes the request for the printer state message information (step S1121: YES), the CPU 11 executes a message generating process (step S1122). The message generating process is a process of generating a response message as the printer state message information.

Note that the printer 1 responds to the external device such as the terminal device 3 with the response message generated in the message generating process in a procedure described later. In a case where the IPP client application 31 of the terminal device 3 receives the response message as the response to the request for the response information transmitted to the printer 1, the IPP client application 31 of the terminal device 3 causes a display, etc., of the terminal device 3 to display the message, in some cases.

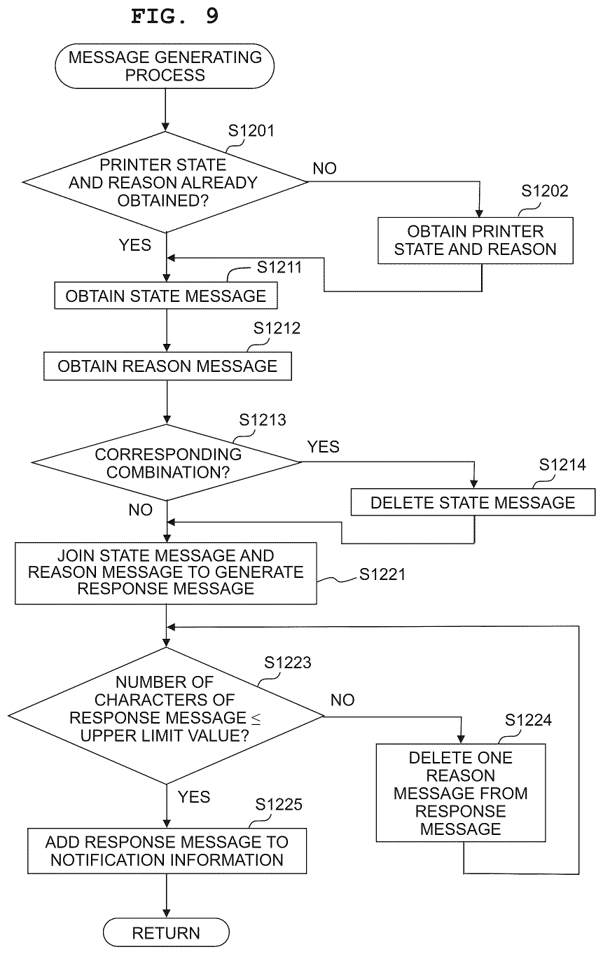

The procedure of the message generating process will be described with reference to the flowchart of FIG. 9. The CPU 11 determines whether the state of the printer 1 and the reason for the state have been obtained (step S1201). In a case where the CPU 11 determines that the state of the printer 1 and the reason for the state have not been obtained (step S1201: NO), the CPU 11 obtains the state of the printer 1 and the reason for the state (step S1202). The step S1202 is similar to step S1102 and step S1112 of the notifying process. Note that in a case where the CPU 11 has already executed step S1102 and step S1112 of the notifying process, the CPU 11 does not need to obtain the information again.

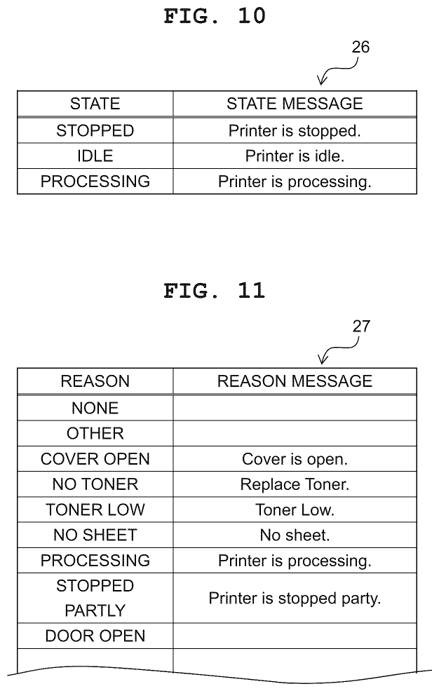

The CPU 11 obtains a state message based on the state of the printer 1 (step S1211). The CPU 11 can obtain the state message based on the state table 26 stored in the memory 12. The state table 26 is, for example, a table which indicates the relationship between the state of the printer 1 and the message with which a response is made as the state of the printer 1, as depicted in FIG. 10.

For example, in a case where the state of printer 1 is “stopped”, the state message is “Printer is stopped.” as depicted in FIG. 10. In other words, the state message expresses in the natural language that the state of the printer 1 is “stopped”. Similarly, in a case where the printer 1 is “idle” or “processing”, the state message is “Printer is idle.” or “Printer is processing.”.

Further, the CPU 11 obtains the reason message based on the reason for the state of the printer 1 (step S1212). The CPU 11 can obtain the reason message based on the reason table 27 stored in the memory 12. The reason table 27 is, for example, a table which indicates the relationship between the reason for the printer 1 to be in the state and the message with which the response is made as the reason for the state of the printer 1, as depicted in FIG. 11. Note that in a case where there are a plurality of reasons, the CPU 11 obtains the reason messages each for one of all the reasons, in step S1212.

For example, in a case where the printer 1 is stopped and the reason therefor is the “cover open”, the reason message is “Cover is open.”, as depicted in FIG. 11. Note that the reason message may be in natural language which conveys the meaning thereof to the user, and does not need to be in the form of a so-called sentence. For example, a reason message indicating that no sheet is stored may be “No sheet.”, as depicted in FIG. 11.

Note that in the reason table 27, no reason message is associated with a state that no particular reason exists or a state that the user does not need to be notified of the reason. As depicted in FIG. 11, the reason table 27 does not store a reason message in a case where the reason for the state is “none” or “other”. In a case where the corresponding reason message is not stored in the reason table 27, the CPU 11 obtains information indicating a blank field in step S1212.

For example, in a case where no reason exists, the user is highly likely to be confused when the user is notified of a message stating that no reason exists. Further, in a case where a reason exists but no code indicating the reason exists, the user is highly likely to be confused when the user is notified of a message indicating that no code indicating the reason exists. By leaving the reason message field blank in these cases, the printer 1 prevents any unnecessary message from being displayed on the terminal device 3, thereby preventing the user from being confused.

Furthermore, as depicted in FIG. 11, there are reasons for which the corresponding reason messages are not stored in the reason table 27. In a case where the printer 1 does not have a configuration which is the reason for the state and where even a reason code based on the IPP standard is prepared therefor, the reason for the state of the printer 1 is not likely to correspond to a reason code thereof. For example, since the printer 1 does not have a door, the printer 1 would not be in the state of “door open”. Therefore, the reason table 27 does not store a reason message associated with the reason of the “door open”. A reason code with which a reason message is not associated is an example of the “special code”.

Further, the CPU 11 determines whether the state message obtained in step S1211 and the reason message obtained in step S1212 are of a corresponding combination (step S1213). In a case where the main parts of two messages, such as words or clauses, are the same, that is, in a case where the two messages share at least a portion of text, the CPU 11 determines that the state message and the reason message are of the corresponding combination. For example, in a case where the state message is “Printer is stopped.” and the reason message is “Printer is stopped partly.”, the phrase “Printer is stopped” is common. A combination in which a state message and a reason message share at least a portion of text is an example of a “specific combination”.

In a case where the CPU 11 determines that the state message and the reason message are of the corresponding combination (step S1213: YES), the CPU 11 deletes the state message obtained in step S1211 and make a change to no message (step S1214). Note that the corresponding combination includes, for example, a combination in which the state message is included in the reason message, a combination in which the state message corresponds with at least a major part of the reason message, and a combination in which the state message and the reason message have the same meanings. The printer 1 may determine whether the state message and the reason message correspond with each other based on the obtained messages, or may have information regarding the corresponding combination in advance.

Depending on the combination of the state and the reason, in a case where both of the state and reason messages are included, such a corresponding combination of the messages might be redundant and confusing to the user, in some cases. Since the printer 1 uses only the reason message as a response message in the corresponding combination, redundant messages are not displayed on the terminal device 3 so that the user can easily understand the message.

After step S1214, or in a case where the CPU 11 determines that the state message and the reason message are not of the corresponding combination (step S1213: NO), the CPU 11 joins the state message and the reason message to generate one response message (step S1221). The CPU 11 causes all of the reason messages obtained in step S1212 to follow the state message so as to generate a response message. The response message generated in step S1221 in a case where the CPU 11 determines that the state message and the reason message are not of the corresponding combination is an example of a “first printer state message”.

Furthermore, in a case where the CPU 11 determines that the state message and the reason message are of the corresponding combination and deletes the state message in step S1214, the CPU 11 generates a response message which includes the reason message but does not include the state message in step S1221. For example, as described above, in a case where the state message is “Printer is stopped.” and the reason message is “Printer is stopped partly.”, the response message is “Printer is stopped partly.” This response message is an example of a “fourth printer state message”.

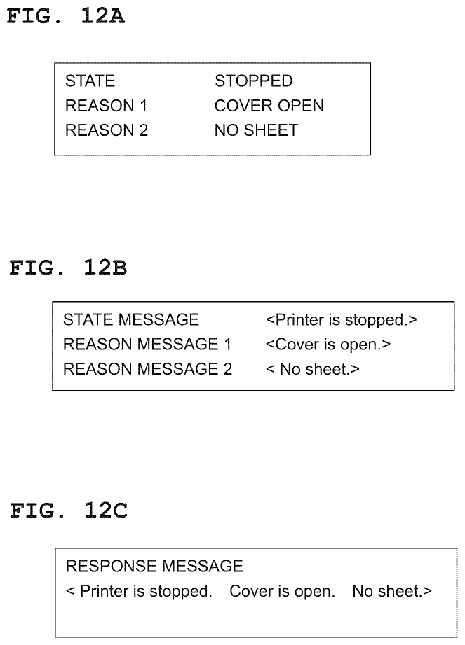

For example, in a case where the state of the printer 1 is stopped, and this stopped state is due to two reasons which are “Cover Open” (reason 1) and “No Sheet” (reason 2) as depicted in FIG. 12A, the state message is “Printer is stopped.” and the reason messages are “Cover is open.” and “No sheet.”, as depicted in FIG. 12B. Further, the response message generated in step S1221 is “Printer is stopped. Cover is open. No sheet.” as depicted in FIG. 12C. In a case where there are multiple reasons, the CPU 11 makes a response by generating a response message which includes reason messages each corresponding to one of the reasons. Thus, in a case where a message based on the response message is displayed on the terminal device 3, the user can understand the reasons for the state in detail.

Further, the CPU 11 obtains the number of characters in the response message generated in step S1221, and determines whether the number of characters is within a range not exceeding a predetermined upper limit value (step S1223). The printer 1 stores in advance a predetermined upper limit value, separately from the upper limit value of the number of characters defined in the IPP standard. The upper limit value stored in the printer 1 of the second embodiment is the number of characters shorter than the upper limit value of the number of characters defined in the IPP standard. For example, the printer 1 may set the number of characters which can be displayed on the operation panel 13 as the upper limit value. Note that the number of characters which can be displayed on the operation panel 13 may be the number of characters which can be displayed at a time without accepting an operation such as scrolling, or the number of characters included on one screen which can be displayed by accepting the operation such as the scrolling. By setting the upper limit value on the number of the characters in the response message, the printer 1 is enabled to convey the user of the detailed reason(s) for the state, while preventing the response message from being redundant.

In a case where the CPU 11 determines that the number of characters in the response message exceeds the upper limit value (step S1223: NO), the CPU 11 reduces the number of the reason messages included in the response message by one (step S1224). For example, the CPU 11 deletes the last reason message. Further, the CPU 11 performs the determination of step S1223 again regarding the response message from which one reason message has been deleted.

Furthermore, even in a case where there is the plurality of reasons, the CPU 11 may include only one reason message in the response message. In a case where there are the multiple reasons, the inclusion of all the reason messages corresponding to the reasons makes the response message redundant, and the reasons are less likely to be conveyed to the user.

Moreover, the procedure of the processes, such as the obtainment of the number of characters in the response message and the comparison of the number of characters with the upper limit value, become complicated. In a case where only the reason message corresponding to one reason is included in the response message, the user can easily read the reason message for the state.

In a case where the CPU 11 determines that the number of the characters in the response message does not exceed the predetermined upper limit value (step S1223: YES), the CPU 11 adds the response message to the notification information (step S1225), ends the message generating process, and returns to the notifying process.

Returning to the description of the notifying process in FIGS. 8A and 8B, after executing the message generating process (step S1122), or in a case where the CPU 11 determines that the received request for the response information does not include the request for the printer state message information (step S1121: NO), the CPU 11 transmits the notification information (step S1131) and ends the notifying process. With this, notification information, including all the requested information, is transmitted.

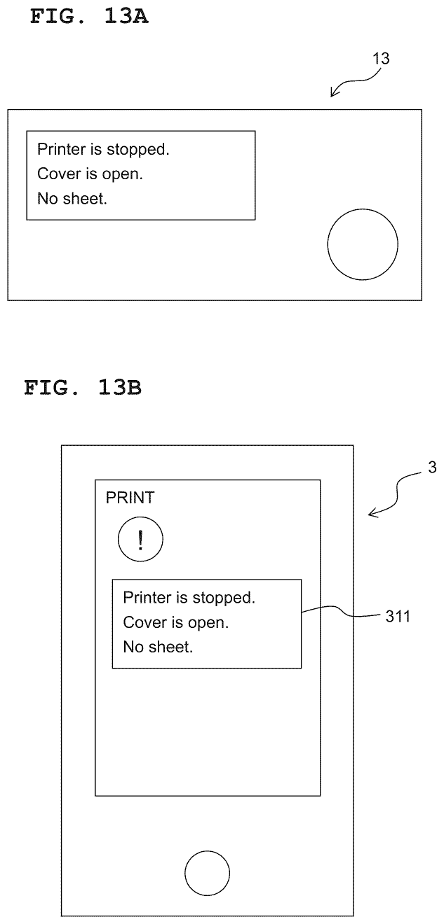

Note that the printer 1 stores, in the memory 12 in advance, a natural language message for notifying the user of the state of the printer 1 and the reason for the state, and can display an appropriate message on the operation panel 13, in accordance with the current state of the printer 1 and the reason therefor. For example, in a case where the state of the printer 1 and the reason therefor are the state and the reasons depicted in FIG. 12A, the printer 1 will display “Printer is stopped. Cover is open. No sheet.” as depicted in FIG. 13A, and can alert the user. The state message displayed on the operation panel 13 by the printer 1 is an example of a “state UI message”. The reason message displayed on the operation panel 13 by the printer 1 is an example of a “reason UI message”. A reason as an object, of the reason message, to be displayed on the operation panel 13 by the printer 1 is an example of a “first reason”.

The state messages stored in the state table 26 depicted in FIG. 10 and the reason messages stored in the reason table 27 depicted in FIG. 11 are the same as the messages stored in the memory 12 to be displayed by the printer 1 on the operation panel 13. That is, the printer 1 generates a response message with the same content as the message displayed on the operation panel 13 in step S1221. By notifying the terminal device 3 of this response message, a message 311 identical to the message displayed on the operation panel 13 is likely to be displayed also on the display of the terminal device 3, for example, as depicted in FIG. 13B.

For example, in a case where the terminal device 3 is notified of a response message different from the message displayed on the operation panel 13 of the printer 1, the message displayed on the terminal device 3 and the message displayed on the operation panel 13 are different, leading to such a fear that the user might misunderstand the state of the printer 1. The printer 1 of the second embodiment generates the same message as the message displayed on the operation panel 13 as the response message, and responds to the terminal device 3. Therefore, even in a case where the message is displayed on the display of the terminal device 3, the possibility that the user might misunderstand the message is low.

Even in a case where the printer 1 displays the state message indicating the state of the printer 1 on the operation panel 13, if the reason for the state does not need to be displayed, the printer 1 displays only the state message. For example, in a case where the state has no particular reason or in a case where there is no need to notify the user of the reason, the printer 1 does not display a reason message on the operation panel 13. The reason which is not displayed by the printer 1 on the operation panel 13 is an example of a “second reason”.

As for the reason the reason message is not displayed on the operation panel 13, information indicating a blank field as the reason message is stored in the reason table 27 depicted in FIG. 11. In a case where the CPU 11 obtains only information indicating a blank field as the reason message in step S1212 of the message generating process, the CPU 11 uses only the state message as it is, as the response message in step S1221. For example, in a case where the state message is “Printer is processing.” and no reason therefor exists, the response message will be “Printer is processing.” This response message is an example of a “second printer state message” and also an example of a “third printer state message”.

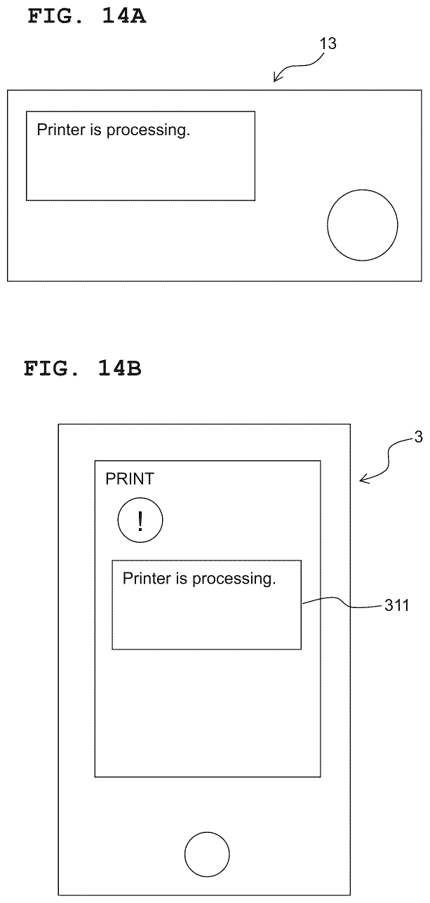

In this case, for example, only the state message is displayed on the operation panel 13, as depicted in FIG. 14A. Then, by notifying the terminal device 3 of this response message, a message 311 including only the state message is also displayed on the display of the terminal device 3, as depicted in FIG. 14B, for example.

In a case where the reason for the state of the printer 1 is the reason which is not displayed on the operation panel 13, the necessity of displaying the reason on the display of the terminal device 3 is low. With respect to the reason for which the reason message is not displayed on the operation panel 13, since the printer 1 makes a response with a response message not including the reason message, the message displayed on the display of the terminal device 3 can be made the same as the message displayed on the operation panel 13. Further, also in this case, the printer 1 makes a response with a response message with the number of characters which can be displayed on the operation panel 13. With this, a message the same as the message displayed on the operation panel 13 is highly likely to be displayed on the display of the terminal device 3, enabling the user to easily understand the message.

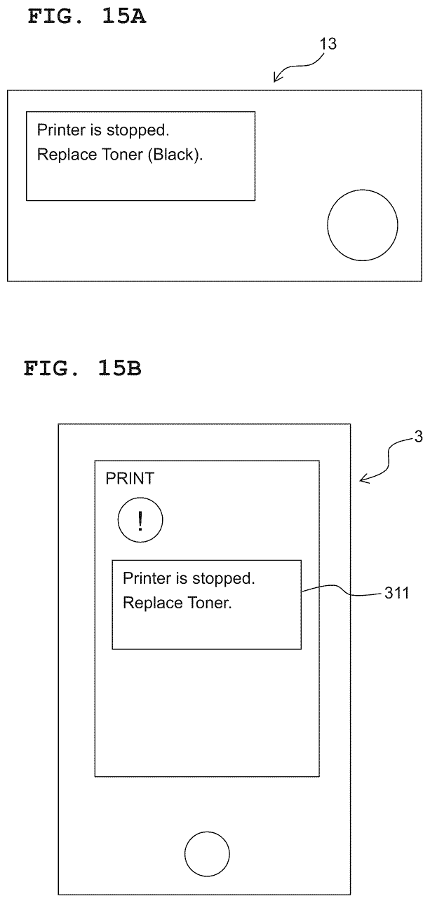

Note that as the reason of the state of the printer 1, the printer 1 may specify a reason which is more detailed than the information corresponding to the reason code, in some cases. For example, in a case where the state of the printer 1 is stopped and the reason for this state is no toner (“No toner”), the printer 1 can further obtain information indicating that there remains no toner of a certain color among a plurality of colors. In this case, the printer 1 can display the obtained detailed information on the operation panel 13. For example, the printer 1 displays, on the operation panel 13, a message including information that there remains no toner of the certain color, as depicted in FIG. 15A. The message including the information of the color is an example of a “detailed reason UI message”. This enables the user to understand the detailed reason. Note that “No toner” includes a case where little toner remains for printing.

Even in a case where there is a detailed reason, the printer 1 notifies the user of a response message which does not include the detailed reason. For example, in a case where the reason for the state is “No toner”, the code defined based on the IPP standard for such a case is only one code indicating “No toner”. Further, only one reason message can be prepared for one reason. In the above-described example, the printer 1 notifies the user of “Printer is stopped. Replace Toner.” as the response message and does not notify the user of the information of the color. As a result, as depicted in FIG. 15B, a message 311 including the state message and a reason message which does not include the detailed reason are displayed on the display of the terminal device 3.

That is, a message similar to the message displayed on the operation panel 13 is also displayed on the display of the terminal device 3, and a message including a more detailed reason is displayed on the operation panel 13. With this, the user, who has seen both the message on the display of the terminal device 3 and the message on the operation panel 13, is less likely to misunderstand the message. Further, since the printer 1 displays the message including the detailed reason on the operation panel 13, the user can be notified of the detailed reason.

As described above in detail, the printer 1 of the second embodiment notifies the terminal device 3 of the response message which is written in the natural language and in which the state message indicating the current state of the printer 1 and the reason message indicating the reason for the printer 1 to be in the current state are combined, in response to the request for the printer state message information from the terminal device 3. With this, since the terminal device 3 can display the response message notified, the detailed state of the printer 1 can be easily conveyed to the user.

Note that the second embodiment is merely an example, and does not limit the present disclosure in any way. Therefore, it goes without saying that various improvements and/or modifications can be made to the present disclosure without departing from the spirit thereof. For example, the printer 1 is not limited to an apparatus exclusive for printing, and may also be a multifunction peripheral, a copying machine, a fax machine, etc. Further, the printing system of the printer 1 is not limited to the electrophotographic system, and may be the ink-jet system, the thermal transfer system, the thermal system, or the like. In a case where the printing system is different, the response message from the printer 1 might be different, in some cases.

Further, in the second embodiment, the request for the state of the printer, the request for the reason information, and the request for the printer state message information are mutually separate pieces of information and are included in one request for response information. However, for example, one request for the response information may include three requests. Further, one or more of the above-described requests may be included in each of a plurality of requests for response information. For example, in a case where the printer 1 receives the request for the printer state message information separately from the request for the state of the printer and the request for the reason information, the printer 1 obtains the state of the printer 1 and the reason for the state in response to reception of the request for the printer state message information, and generates the message.

Furthermore, the information requested by the terminal device 3 is not limited to the state of the printer 1, the reason, and the message. In a case where other information is requested, the printer 1 makes a response with the other information, in response to the request.

Moreover, in the second embodiment, the printer 1 generates the response message by causing the reason message to follow the state message, but the order may be reversed. However, the user can easily understand the content of the message in a case where the reason message follows the state message. Further, in the second embodiment, although the message in the English language is exemplified, any natural language may be used, and the language of the message is not limited to the English language.

Furthermore, in the second embodiment, the printer 1 stores in advance the upper limit value of the number of characters in the response message. However, the printer 1 may, for example, determine the upper limit value based on the IPP standard, or the printer 1 may accept the upper limit value set by the user. Further, the upper limit value is not limited only to the upper limit value of the number of the characters, and an upper limit value may be set for the number of the reason messages to be included in the response message.

Moreover, in the second embodiment, in a case where the reason is the “other”, the printer 1 leaves the reason message field blank. However, with respect to a reason not having a reason code therefor, the printer 1 may display the reason on the operation panel 13 and the printer 1 may, for example, include a message for urging the user to see the operation panel 13 in the response message.

Further, in the second embodiment, the printer 1 makes the response to the request for information in accordance with the IPP standard, the standard is not limited to the IPP standard. The printer 1 may respond to a request according to, for example, a standard defined by the OS of the terminal device, a standard defined by the vendor of the printer 1, or a standard defined by a platform on the Internet.

The printer of the second embodiment may be configured to perform printing based on a print job received from an external device, wherein the printer may be configured to: notify the external device of a state code indicating a current state of the printer, in response to a first request from the external device; notify the external device of a reason code indicating a reason for the current state of the printer, in response to a second request from the external device; and notify the external device of a first printer state message in which a state message and a reason message are combined, in response to a third request from the external device, the state message being composed in natural language indicating the current state of the printer, the reason message being composed in the natural language indicating the reason for the current state of the printer.

In the printer of the second embodiment, in a case where the current state of the printer is a predetermined state and a reason for the predetermined state is a predetermined reason, the printer may be configured to display a state UI message composed in the natural language indicating that the printer is in the predetermined state and a reason UI message composed in the natural language indicating the predetermined reason, on a user interface of the printer, and in a case where the printer receives the third request from the external device in a situation where the current state of the printer is the predetermined state and the reason for the predetermined state is the predetermined reason, the printer may be configured to notify the external device of the first printer state message including the state UI message as the state message and the reason UI message as the reason message.

In the printer of the second embodiment, the reason for the predetermined state of the printer may include a first reason to be displayed on the user interface as the reason UI message and a second reason not to be displayed on the user interface as the reason UI message, in a case where the printer receives the third request from the external device in a situation where the current state of the printer is the predetermined state and the reason for the predetermined state of the printer is the first reason, the printer may be configured to notify the external device of the first printer state message including the state UI message as the state message and the reason UI message as the reason message, and in a case where the printer receives the third request from the external device in a situation where the current state of the printer is the predetermined state and the reason for the predetermined state of the printer is the second reason, the printer may be configured to notify the external device of a second printer state message including the state UI message as the state message and not including the reason message.

In response to the third request from the external device, the printer of the second embodiment may be configured to: notify the external device of the first printer state message in which the state message and the reason message are combined, in a case where the reason code corresponding to the reason for the current state of the printer is not a special code; and notify the external device of a third printer state message including the state message and not including the reason message, in a case where the reason code corresponding to the reason for the current state of the printer is the special code.

In the printer of the second embodiment, the special code may be the reason code indicating that the reason for the current state of the printer does not exist.

In the printer of the second embodiment, the special code may be the reason code indicating that the reason for the current state of the printer exists, whereas a code indicating the reason does not exist.

In the printer of the second embodiment, the special code may be the reason code with which a message is not associated.

In the printer of the second embodiment, the state code and the reason code may be defined by a standard to which the external device conforms, and the state message and the reason message may not be defined by the standard to which the external device conforms.

The printer of the second embodiment may be configured to specify a detailed reason regarding a specific reason indicated in a specific reason code defined by the standard to which the external device conforms, and in a case where the reason for the current state of the printer is the specific reason, the printer may be configured to notify the external device of the first printer state message in which the state message and the reason message corresponding to the specific reason code are combined and which does not include a message composed in the natural language indicating the detailed reason, in response to the third request from the external device.

In the printer of the second embodiment, in the case where the reason for the current state of the printer is the specific reason, the printer may be configured to display a state UI message indicating the current state of the printer and a detailed reason UI message indicating the detailed reason, on the user interface of the printer, and in a case where the printer receives the third request from the external device in a situation where the reason for the current state of the printer is the specific reason, the printer may be configured to notify the external device of the first printer state message in which the state message and the reason message corresponding to the specific reason code are combined and which does not include a message composed in the natural language indicating the detailed reason.

The printer of the second embodiment may be configured to perform color printing by using a plurality of colorants of different colors, the specific reason may be a shortage in the plurality of colorants, and the detailed reason may be the shortage of a specific colorant of the plurality of colorants.

In a case where the reason for the current state of the printer includes a plurality of reasons, the printer of the second embodiment may be configured to notify the external device of reason codes corresponding to the plurality of reasons respectively in response to the second request from the external device, and in a case where the printer receives the third request from the external device and the reason for the current state of the printer includes the plurality of reasons, the printer may be configured to notify the external device of the first printer state message in which the state message and reason messages corresponding to the plurality of reasons respectively are combined.

In the case where the printer receives the third request from the external device and the reason for the current state of the printer includes the plurality of reasons, the printer of the second embodiment may be configured to notify the external device of the first printer state message including the state message and the reason messages corresponding to the plurality of reasons respectively, within a range in which the number of characters of the first printer state message does not exceed an upper limit value.

In a case where the reason for the current state of the printer includes a plurality of reasons, the printer of the second embodiment may be configured to notify the external device of reason codes corresponding to the plurality of reasons respectively in response to the second request from the external device, and in a case where the printer receives the third request from the external device and the reason for the current state of the printer includes the plurality of reasons, the printer may be configured to notify the external device of the first printer state message in which the state message and a reason message corresponding to one reason selected from the plurality reasons are combined.

In response to the third request from the external device, the printer of the second embodiment may be configured to: notify the external device of the first printer state message in which the state message and the reason message are combined, in a case where a combination of the current state of the printer and the reason for the current state of the printer is not a specific combination; and notify the external device of a fourth printer state message including the reason message and not including the state message, in a case where the combination of the current state of the printer and the reason for the current state of the printer is the specific combination.

In the printer of the second embodiment, the specific combination may be a combination in which the state message indicating the current state corresponds with at least a main part of the reason message indicating the reason.

In accordance with an Internet Printing Protocol standard, the printer of the second embodiment may be configured to: notify the external device of the state code, in a case where the printer receives the “printer-state” command as the first request from the external device; notify the external device of the reason code, in a case where the printer receives the “printer-state-reasons” command as the second request from the external device; and notify the external device of the first printer state message, in a case where the printer receives the “printer-state-message” command as the third request from the external device.

### Third Embodiment

Conventionally, a procedure has been disclosed in which a printer transmits the state of a print job inputted to the printer by a message composed in natural language to an IPP client, which is configured to generate a print job in accordance with the IPP standard. However, the manner of generating the message is entrusted to the printer. Accordingly, the procedure for generating the message in the printer can be improved further.

In the following, a third embodiment configured to solve the above-described problem will be described in detail with reference to the accompanying drawings. Similarly to the first and second embodiments, a printer 1 of the third embodiment also can execute printing based on a printing instruction according to the IPP standard, and has the configuration as depicted in FIG. 1. Note that the printer 1 of the third embodiment includes a print engine 15 of which printing system is, for example, the electrophotographic system. The print engine 15 is capable of performing color printing with a plurality of toners of mutually different colors. Further, in the printer 1 of the third embodiment, the notification information 23 may not include the prohibition table 24 and the resolution table 25.

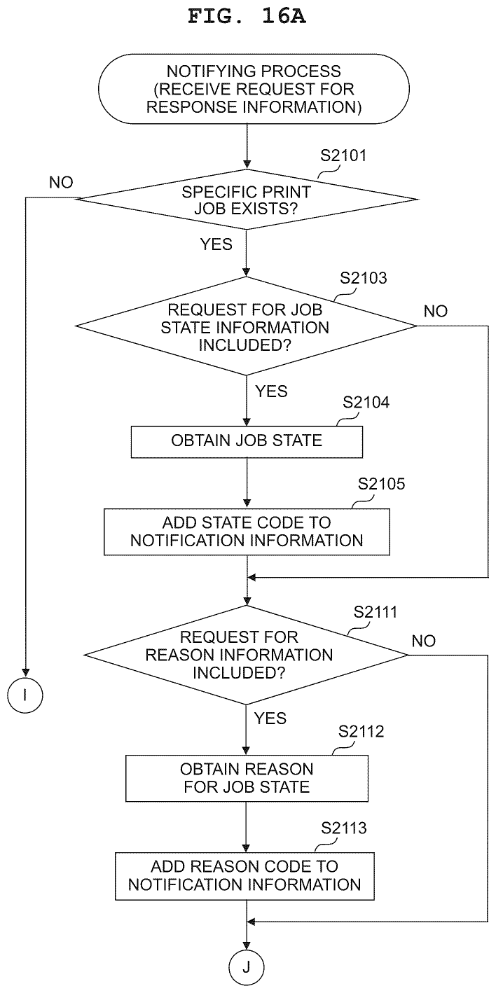

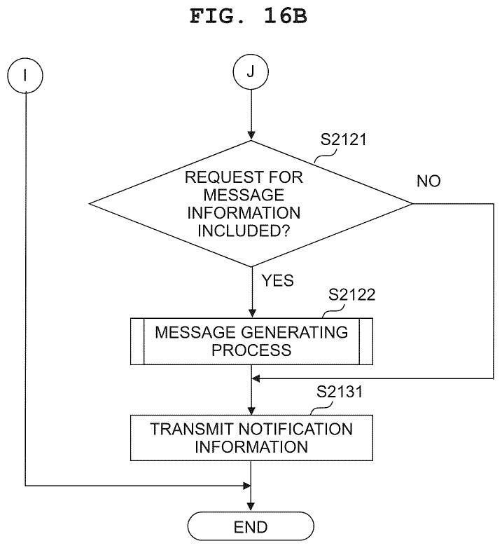

The procedure of a notifying process executed by the printer 1 of the third embodiment will be described with reference to the flowchart of FIGS. 16A and 16B. The CPU 11 of the printer 1 executes the notifying process based on the IPP response program 21 upon receiving a request for response information from an external device such as the terminal device 3.

Note that the IPP client application 31 has a function of communicating with the printer 1, which is a device caused by the IPP client application 31 to execute the printing, and requesting the printer 1 to transmit information. In some cases, for example, after the IPP client application 31 has transmitted a print job to the printer, the IPP client application 31 requests the printer 1 of information indicating the state of the transmitted print job. For example, in a case where the printer 1 receives the request for the response information from the terminal device 3, the printer 1 can generate the requested information based on a command included in the request for the response information and respond to the terminal device 3.

In a case where the received request for the response information includes a request for information regarding a specific print job, the CPU 11 determines whether a specific print job, for which information is requested, exists (step S2101). In a case where the CPU 11 determines that no specific print job, for which information is requested, exists (step S2101: NO), the CPU 11 ends the notifying process. The CPU 11 may transmit information indicating that no specific print job for which information is requested, exists.

The IPP client application 31 can identify the print job for which the IPP client application 31 has transmitted the execution instruction to the printer 1, based on a user name indicating a logged-in user in a case where the execution instruction was received, a file name of an object to be printed, etc. Further, the IPP client application 31 can specify the print job inputted to the printer 1 based on, for example, the instruction from the user, and can make a request of the printer 1 for information about the specified print job.

Furthermore, in a case where the printer 1 receives the print job from the terminal device 3, etc., for example, the printer 1 generates identification information for identifying the inputted print job, and manages the information regarding the print job at least until the processing of the print job is completed. Moreover, in a case where the printer 1 receives specification of the inputted print job and the request for the information regarding the specified print job, the printer 1 determines whether the printer 1 has the information about the print job. Note that the printer 1 may delete the information of the print job for which the processing has been completed, or may retain the information even after the processing has been completed.

In a case where the CPU 11 determines that the specific print job, for which information is requested by the request for the response information, exists (step S2101: YES), the CPU 11 determines whether a request for job state information, which is information indicating the state of the specific print job, is included in the received request for the response information (step S2103). The job state information is information indicating the current state of a predetermined job. The request for the job state information is an example of a “first request”. A request for the job state information based on the IPP standard is, for example, a “job-state” command.

In a case where the CPU 11 determines that the request for the job state information is included (step S2103: YES), the CPU 11 obtains the state of the print job (step S2104). The state of the print job includes, for example, “pending”, “being processed”, “canceled”, “aborted”, and “completed”.

Further, the CPU 11 adds a state code, which is information indicating the obtained state of the print job, to notification information (step S2105). The state code is information defined for each state of the job based on the IPP standard to which the terminal device 3 conforms. The notification information is information which is responded to the terminal device 3 in a procedure described later. Note that at the start of the notification process, the notification information does not include any information.

After step S2105, or in a case where the CPU 11 determines that the received request for the response information does not include the request for the job state information (step S2103: NO), the CPU 11 determines whether the received request for the response information includes a request for job state reason information (step S2111). The job state reason information is information indicating the reason for the print job to be in the (current) state. The reason for the state of the job includes various reasons, the number of which is greater than the number of the states. For example, the reason for the job to be canceled includes reasons such as “canceled by a user”, “canceled by an operator other than the user”, “canceled from the operation panel”, and so on. The request for the job state reason information is an example of a “second request”. The request for the job state reason information based on the IPP standard is, for example, a “job-state-reasons” command.

In a case where the CPU 11 determines that the received request for the response information includes the request for the job state reason information (step S2111: YES), the CPU 11 obtains the reason for the print job to be in the state (step S2112). Note that in a case where the CPU 11 has obtained the reason for the state of the print job in step S2104, the CPU 11 may skip step S2112.

Furthermore, the CPU 11 adds a reason code, which is information indicating the reason for the print job to be in the state, to the notification information (step S2113). The reason code is information defined for each reason for the state of the job based on the IPP standard to which the terminal device 3 conforms. Note that in a case where the reason for the state of the job includes a plurality of reasons, the CPU 11 obtains the plurality of reasons and adds all the plurality of reason codes, which correspond to the obtained plurality of reasons, respectively, to the notification information.

Further, depending on the state of the job, there may be no reason for the state. For example, in a case where the job is being queued to be executed, no particular reason for the job to be queued exists. In a case where the CPU 11 is unable to obtain the reason in step S2112, that is, in a case where no reason exists, the CPU 11 adds a reason code indicating “none” in step S2113. The reason code indicating “none” is a reason code indicating that no reason exists, and is an example of a “special code”.

Furthermore, in a case where a reason code for the reason that the CPU 11 has obtained in step S2112 is not defined based on the IPP standard, the CPU 11 adds a reason code indicating “other” in step S2113. The reason code indicating “other” is a reason code indicating that no reason code corresponding to the reason exists, and is an example of the “special code”.

After step S2113, or in a case where the CPU 11 determines that the received request for the response information does not include the request for the job state reason information (step S2111: NO), the CPU 11 determines whether a request for job state message information is included in the received request for the response information (step S2121). The job state message information is a message expressing the current state of a predetermined job and the reason for that state in natural language. The request for the job state message information is an example of a “third request”. The request for the job state message information based on the IPP standard is, for example, a “job-state-message” command. Note that in the present specification, a message in the English language is exemplified as the message in the natural language.

Although the state code added in step S2105 and the reason code added in step S2113 are previously determined based on the IPP standard, the job state message information requested in step S2121 is not determined based on the IPP standard. A vendor of the printer is capable of freely preparing the job state message information for the response. Therefore, the degree of freedom of messages is high. The printer 1 prepares one message for one reason code as the message information for the response to a request based on the IPP standard. Therefore, the printer 1 responds to the request with message information previously determined for each of reason codes.

In a case where the CPU 11 determines that the received request for the response information includes the request for the job state message information (step S2121: YES), the CPU 11 executes a message generating process (step S2122). The message generating process is a process of generating a response message with which the response is made as the job state message information.

Note that the printer 1 responds to the external device such as the terminal device 3 with the response message generated in the message generating process in a procedure described later. In a case where the IPP client application 31 of the terminal device 3 receives the response message as the response to the request for the response information transmitted to the printer 1, the IPP client application 31 of the terminal device 3 can cause a display, etc., of the terminal device 3 to display the message.

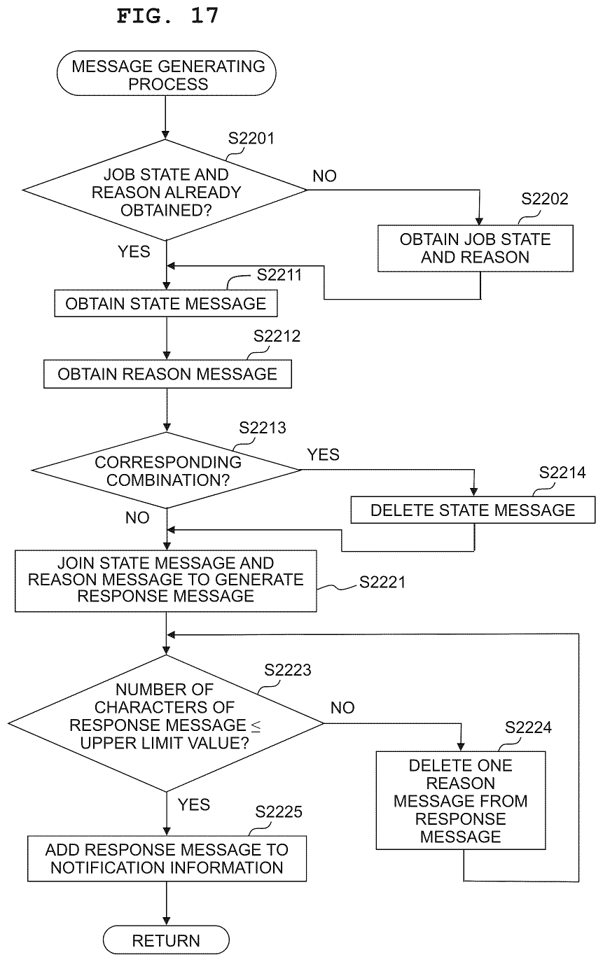

The procedure of the message generating process will be described with reference to the flowchart of FIG. 17. The CPU 11 determines whether the state of a specified, predetermined print job and the reason for the state have been obtained (step S2201). In a case where the CPU 11 determines that the state of the predetermined job and the reason for the state have not been obtained (step S2201: NO), the CPU 11 obtains the state of the predetermined print job and the reason for the state (step S2202). The step S2202 is similar to step S2104 and step S2112 of the notifying process. Note that in a case where the CPU 11 has already executed step S2104 and step S2112 of the notifying process, the CPU 11 does not need to obtain the information again.

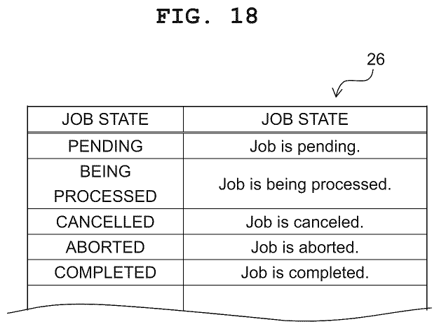

The CPU 11 obtains a state message based on the state of the job (step S2211). The CPU 11 can obtain the state message based on the state table 26 stored in the memory 12. The state table 26 is, for example, a table which indicates the relationship between the state of the job and the message with which a response is made as the state of the job, as depicted in FIG. 18. Note that the state of the job inputted to the printer 1 is included in the state of the printer 1. Namely, the state of the job inputted to the printer 1 can be considered as a subordinate concept of the state of the printer 1.

For example, in a case where the state of the specified print job is “being processed”, the state message is “Job is being processed.” as depicted in FIG. 18. In other words, the state message expresses, in the natural language, that the state of the print job is “being processed”. The state table 26 stores messages each of which is expressed in the natural language for each state of the print job.

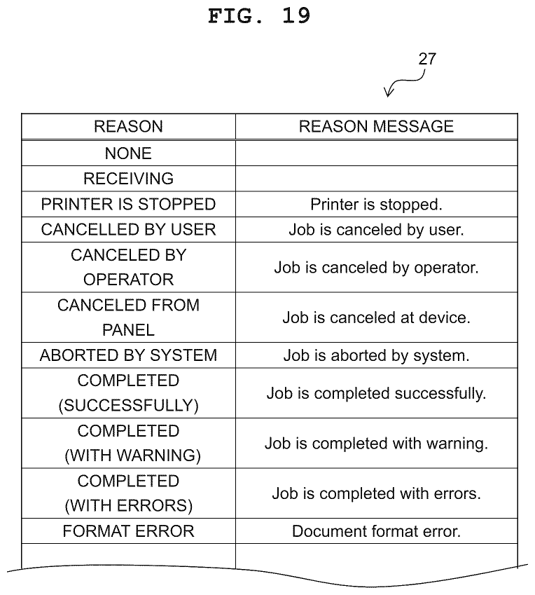

Further, the CPU 11 obtains the reason message based on the reason for the state of the job (step S2212). The CPU 11 can obtain the reason message based on the reason table 27 stored in the memory 12. The reason table 27 is, for example, a table which indicates the relationship between the reason for the job to be in the state and the message with which the response is made as the reason for the state of the job, as depicted in FIG. 19. Note that in a case where there are a plurality of reasons, the CPU 11 obtains the reason messages each for one of all the reasons, in step S2212.

For example, in a case where the printer 1 is stopped, thereby causing the execution of the print job to be pending, the reason message is “Printer is stopped.” as depicted in FIG. 19. Note that the reason message may be in natural language which conveys the meaning thereof to the user, and does not need to be in the form of a so-called sentence. For example, in a case where the printer 1 aborts the processing of the print job due to an error in the format of a document to be printed, a reason message therefor may be “Document format error.”, as depicted in FIG. 19.

Note that in the reason table 27, no reason message is associated with a state that no particular reason exists or a state that a reason does not need to be notified to the user. As depicted in FIG. 19, the reason table 27 does not store a reason message in a case where the reason for the state is “none” or “being received”. In a case where the corresponding reason message is not stored in the reason table 27 in step S2212, the CPU 11 obtains information indicating a blank field in step S2212.

For example, in a case where no reason exists, the user is highly likely to be confused when the user is notified of a message stating that no reason exists. Further, in a case where a reason exists but no code indicating the reason exists, the user is highly likely to be confused when the user is notified of a message indicating that no code indicating the reason exists. By leaving the reason message fields blank in these cases, the printer 1 prevents any unnecessary message from being displayed on the terminal device 3, thereby preventing the user from being confused.

Further, the CPU 11 determines whether the state message obtained in step S2211 and the reason message obtained in step S2212 are of a corresponding combination (step S2213). In a case where the main parts of two messages, such as words or clauses, are the same, that is, in a case where the two messages share at least a portion of text, the CPU 11 determines that the state message and the reason message are of the corresponding combination. For example, in a case where the state message is “Job is canceled.” and the reason message is “Job is canceled by user.”, the phrase “Job is canceled” is common. A combination in which a state message and a reason message share at least a portion of text is an example of a “specific combination”.

In a case where the state of the job is “canceled”, “aborted”, or “completed”, the state message and reason message are likely to be of the corresponding combination. For example, in a case where the state of the job is “canceled”, “aborted”, or “completed”, the CPU 11 determines whether the state message obtained in step S2211 corresponds with any one of the reason messages obtained in step S2212. Further, in a case where the state of the job is neither “canceled”, “aborted”, nor “completed”, the CPU 11 may determine that the state message does not correspond with the reason message.

In a case where the CPU 11 determines that the state message and the reason message are of the corresponding combination (step S2213: YES), the CPU 11 deletes the state message obtained in step S2211 and make a change to no message (step S2214). Note that the corresponding combination is not limited, for example, to a combination in which the state message is included in the reason message; the corresponding combination may be, for example, a combination in which the state message corresponds with at least a major part of the reason message, and a combination in which the state message and the reason message have the same meanings. The printer 1 may determine whether the state message and the reason message correspond with each other based on each of the obtained messages, or may have information regarding the corresponding combination in advance.

Depending on the combination of the state and the reason, in a case where both of the messages are included, such a corresponding combination of the messages might be redundant and confusing to the user, in some cases. Since the printer 1 uses only the reason message as a response message in the corresponding combination, redundant messages are not displayed on the terminal device 3 so that the user can easily understand the message.

After step S2214, or in a case where the CPU 11 determines that the state message and the reason message are not of the corresponding combination (step S2213: NO), the CPU 11 joins the state message and the reason message to generate one response message (step S2221). The CPU 11 causes all of the reason messages obtained in step S2212 to follow the state message so as to generate a response message. The response message generated in step S2221 in a case where the CPU 11 determines that the state message and the reason message are not of the corresponding combination is an example of a “first job state message”. In a case where there are multiple reasons, the CPU 11 makes a response by generating a response message which includes reason messages each corresponding to one of the plurality of reasons. Thus, in a case where the terminal 3 displays a message based on the response message, the user can understand the reasons for the state in detail.

Further, since the CPU 11 obtains the information indicating the blank field in step S2212 in a case where no reason for the state of the job exists, or in a case where the reason message corresponding to the reason is not stored in the reason table 27, the CPU 11 generates a response message including only the state message in step S2221. The response message generated in step S2221 in the case where no reason message exists is an example of a “second job state message”.

Furthermore, in a case where the CPU 11 determines that the state message and the reason message are of the corresponding combination and deletes the state message in step S2214, the CPU 11 generates a response message which includes the reason message but does not include the state message in step S2221. For example, as described above, in a case where the state is “canceled” and the reason is “canceled by user” as described above, the response message is “Job is canceled by user.”. The response message including the reason message but not including the state message is an example of a “third job state message”.

Note that in a case where the CPU 11 obtains a plurality of reason messages in step S2212 and one reason message of the plurality of reason messages corresponds with the state message obtained in step S2211, the CPU 11 may generate a response message wherein the reason message corresponding with the state message is arranged at the head of the response message. For example, in a case where the CPU 11 obtains “Job is aborted.” as the state message indicating the state of the job, and obtains two reason messages indicating the reasons which are “Document format error.” and “Job is aborted by system.”, the printer 1 arranges the latter message corresponding with the state message first, and generates a response message which reads: “Job is aborted by system. Document format error.”. With this, in a case where the terminal device 3 displays this response message, the message indicating the state of the job is displayed first, causing the user to easily understand the content of the message.

Further, the CPU 11 obtains the number of characters in the response message generated in step S2221, and determines whether the number of characters is within a range not exceeding a predetermined upper limit value (step S2223). The printer 1 has a predetermined upper limit value stored therein in advance, separately from the upper limit value of the number of characters defined in the IPP standard. The upper limit value stored in the printer 1 of the third embodiment is the number of characters shorter than the upper limit value of the number of characters defined in the IPP standard. For example, the printer 1 may set the number of characters which can be displayed on the operation panel 13 as the upper limit value. Note that the number of characters which can be displayed on the operation panel 13 may be the number of characters which can be displayed at a time without accepting an operation such as scrolling, or the number of characters included in on one screen which can be displayed by accepting the operation such as the scrolling. By setting the upper limit value on the number of the characters in the response message, the printer 1 is enabled to notify the user of the detailed reason for the state, while preventing the response message from being redundant.

In a case where the CPU 11 determines that the number of characters in the response message exceeds the upper limit value (step S2223: NO), the CPU 11 reduces the number of the reason messages included in the response message by one (step S2224). For example, the CPU 11 deletes the last reason message. Further, the CPU 11 performs the determination of step S2223 again regarding the response message from which one reason message has been deleted.

Furthermore, even in a case where the plurality of reasons exist, the CPU 11 may include only one reason message in the response message. In a case where the plurality of reasons exist, the inclusion of all the reason messages corresponding to the reasons makes the response message redundant, and the reasons are less likely to be conveyed to the user. Moreover, the procedure of the processes, such as the obtainment of the number of characters in the response message and the comparison of the number of characters with the upper limit value, becomes complicated. In a case where only the reason message corresponding to one reason is included in the response message, the user can easily read the reason message for the state.

In a case where the CPU 11 determines that the number of the characters in the response message does not exceed the predetermined upper limit value (step S2223: YES), the CPU 11 adds the response message to the notification information (step S2225), ends the message generating process, and returns to the notifying process.

Returning to the description of the notifying process in FIGS. 16A and 16B. After executing the message generating process (step S2122), or in a case where the CPU 11 determines that the received request for the response information does not include the request for the job state message information (step S2121: NO), the CPU 11 transmits the notification information (step S2131) and ends the notifying process. With this, notification information, including all the requested information, is transmitted.

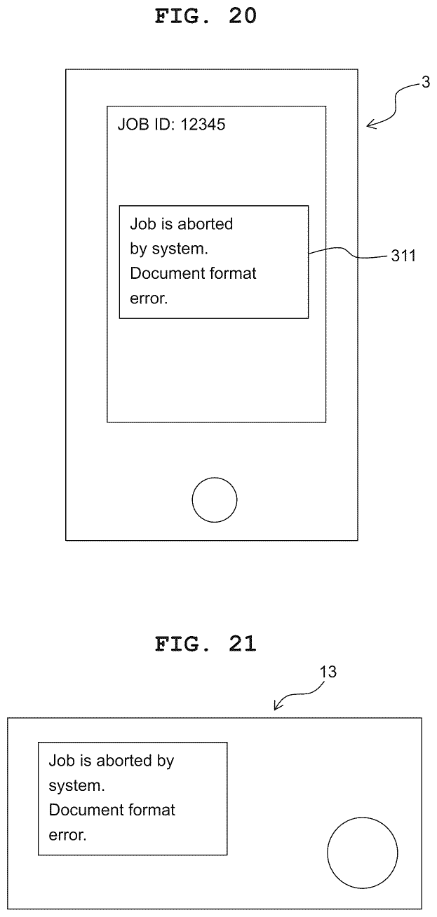

The printer 1 notifies the terminal device 3 of the response message, and the terminal device 3 can display the message in the natural language notified from the printer 1 as a response message 311 on the display, for example, as depicted in FIG. 20.

Note that the printer 1 may be capable of displaying information regarding the received print job on the operation panel 13, regardless of the request from the terminal device 3. For example, the printer 1 may be capable of receiving, via the operation panel 13, the specification of the print job and an instruction for displaying the state of the specified print job and/or the reason therefor.

Further, in a case where the printer 1 receives the instruction to display the information of the print job through an operation on the operation panel 13, the printer 1 may generate the message including the state message and the reason message in the same manner as in steps S2201 to S2224 of the message generating process depicted in FIG. 17, and may display the message on the operation panel 13, for example, as depicted in FIG. 21. For example, a response message with the number of characters which can be displayed on the operation panel 13 is generated in step S2223, which increases the possibility that a message the same as the message displayed on the operation panel 13 would be displayed on the display of the terminal device 3, so that the user can easily understand the message.

As described above in detail, in a case where the printer 1 of the third embodiment receives the request for the job state message from the terminal device 3, the printer 1 generates the response message which is composed in the natural language and in which the state message indicating the state of the predetermined job inputted to the printer 1 and the reason message indicating the reason for the predetermined job to be in the state are combined, and the printer 1 notifies the terminal device 3 of the response message. This enables the terminal device 3 to display the response message, causing the detailed state of the predetermined job to be easily conveyed to the user.

Note that the third embodiment is merely an example, and does not limit the present disclosure in any way. Therefore, it goes without saying that various improvements and/or modifications can be made to the present disclosure without departing from the spirit thereof. For example, the printer 1 is not limited to an apparatus exclusive for printing, and may also be a multifunction peripheral, a copying machine, a fax machine, etc. Further, the printing system of the printer 1 is not limited to the electrophotographic system, and may be the ink-jet system, the thermal transfer system, the thermal system, or the like.

Further, in the third embodiment, the request for the state of the job, the request for the reason information, and the request for the job state message information are mutually separate pieces of information and are included in one request for response information. However, for example, one request for the response information may include three requests. Further, one or more of the above-described requests may be included in each of a plurality of requests for response information. For example, in a case where the printer 1 receives the request for the job state message information separately from the request for the state of the job and the request for the reason information, the printer 1 obtains the state of the job and the reason for the state in response to receiving the request for the job state message information, and generates the message.

Furthermore, the information requested by the terminal device 3 is not limited to the state of the job, the reason, and the message. In a case where other information is requested, the printer 1 makes a response with the other information, in response to the request. Moreover, in the third embodiment, although the procedure of generating the response message with respect to one job has been described, the printer 1 may be capable of receiving a request for response information with respect to a plurality of jobs. In a case where the printer 1 receives the request for the response information with respect to the plurality of jobs, the printer 1 may generate a response message for each of the jobs and make a response while associating the response message with each of the jobs.

Further, in the third embodiment, the information specifying the print job is included in the request for the response information, separately from the request for the state of the job, the request for the reason information, and the request for the job state message information. The information specifying the print job, however, may be associated with each of the above-described requests. In this case, in a case where the CPU 11 determines YES in each of step S2103, step S2111 and step S2121 of the notifying process, the CPU 11 may determine whether the specified print job exists, based on the information associated with each of the requests.

Furthermore, although the reason code indicating “other” as the reason for the state of the job exists in the third embodiment, the reason code indicating “other” may not exist in the third embodiment. Moreover, the printer 1 may be capable of obtaining a detailed reason not corresponding to a reason code which can be responded to the terminal device 3. In a case where the printer 1 obtains the detailed reason, the printer 1 may display the obtained detailed reason on the operation panel 13.

Moreover, in the third embodiment, the printer 1 generates the response message by causing the reason message to follow the state message, but the order may be reversed. However, the user can easily understand the content of the message in a case where the reason message follows the state message. Further, in the third embodiment, although the message in the English language is exemplified, the language of the message is not limited to the English language. Any natural language may be used.

Furthermore, in the third embodiment, the printer 1 has the upper limit value of the number of characters in the response message stored therein in advance. For example, the printer 1 may determine the upper limit value based on the IPP standard or accept the upper limit value set by the user. Further, the upper limit value is not limited only to the upper limit value of the number of the characters, and an upper limit value may be set for the number of the reason messages to be included in the response message.

Moreover, in the third embodiment, in a case where no reason exists, the printer 1 leaves the reason message field blank. However, in a case where no reason code exists but a reason exists, the printer 1 may display the reason on the operation panel 13 and the printer 1 may, for example, include a message urging the user to see the operation panel 13 in the response message.

Further, in the third embodiment, the printer 1 makes the response to the request for information in accordance with the IPP standard, the standard is not limited to the IPP standard. The printer 1 may respond to a request according to, for example, a standard defined by the OS of the terminal device, a standard defined by the vendor of the printer 1, or a standard defined by a platform on the Internet.

The printer of the third embodiment may be configured to perform printing based on a print job received from an external device, wherein the printer may be configured to: notify the external device of a state code indicating a current state of a predetermined job inputted to the printer, in response to a first request from the external device with respect to the predetermined job; notify the external device of a reason code indicating a reason for the current state of the predetermined job, in response to a second request from the external device with respect to the predetermined job; and notify the external device of a first job state message in which a state message and a reason message are combined, in response to a third request from the external device with respect to the predetermined job, the state message being composed in natural language indicating the current state of the predetermined job, the reason message being composed in the natural language indicating the reason for the current state of the predetermined job.

In response to the third request from the external device, the printer of the third embodiment may be configured to: notify the external device of the first job state message in which the state message and the reason message are combined, in a case where the reason code corresponding to the reason for the current state of the predetermined job is not a special code; and notify the external device of a second job state message including the state message and not including the reason message, in a case where the reason code corresponding to the reason for the current state of the predetermined job is the special code.

In the printer of the third embodiment, the special code may be the reason code indicating that the reason for the current state of the predetermined job does not exist.

In the printer of the third embodiment, the special code may be the reason code indicating that the reason for the current state of the predetermined job exists whereas a code indicating the reason does not exist.

In the printer of the third embodiment, the special code may be the reason code with which a message is not associated.

In the printer of the third embodiment, the state code and the reason code may be defined by a standard to which the external device conforms, and the state message and the reason message may not be defined by the standard to which the external device conforms.

In a case where the reason for the current state of the predetermined job includes a plurality of reasons, the printer of the third embodiment may be configured to notify the external device of the reason codes corresponding to the plurality of reasons respectively, in response to the second request from the external device; and in a case where the printer receives the third request from the external device and the reason for the current state of the predetermined job includes the plurality of reasons, the printer may be configured to notify the external device of the first job state message in which the state message and reason messages corresponding to the plurality of reasons are combined.

In a case where the printer of the third embodiment receives the third request from the external device and the reason for the current state of the predetermined job includes the plurality of reasons, the printer may be configured to notify the external device of the first job state message including the state message and reason messages corresponding to the plurality of reasons respectively, within a range in which the number of characters of the first job state message does not exceed an upper limit value.

In a case where the reason for the current state of the predetermined job includes a plurality of reasons, the printer of the third embodiment may be configured to notify the external device of reason codes corresponding to the plurality of reasons respectively, in response to the second request from the external device; and in a case where the printer receives the third request from the external device and the reason for the current state of the predetermined job includes the plurality of reasons, the printer may be configured to notify the external device of the first job state message in which the state message and the reason message corresponding to one reason selected from the plurality of reasons are combined.

In response to the third request from the external device, the printer of the third embodiment may be configured to: notify the external device of the first job state message in which the state message and the reason message are combined, in a case where a combination of the current state of the predetermined job and the reason for the current state of the predetermined job is not a specific combination; and notify the external device of a third job state message including the reason message and not including the state message, in a case where the combination of the current state of the predetermined job and the reason for the current state of the predetermined job is the specific combination.

In the printer of the third embodiment, the specific combination may be a combination in which the state message indicating the current state corresponds with at least a main part of the reason message indicating the reason.

In accordance with an Internet Printing Protocol standard, the printer of the third embodiment may be configured to: notify the external device of the state code, in a case where the printer receives the “job-state” command as the first request from the external device; notify the external device of the reason code, in a case where the printer receives the “job-state-reasons” command as the second request from the external device; and notify the external device of the first job state message, in a case where the printer receives the “job-state-message” command as the third request from the external device.

Further, in any of the flowcharts disclosed in each of the first to third embodiments, the execution order of a plurality of processes in any plurality of steps can be changed in any way or executed in parallel as long as no inconsistency arises in the contents of the processes.

Furthermore, the process disclosed in each of the first to third embodiments may be executed by hardware such as a single CPU, a plurality of CPUs, an ASIC, etc., or by a combination thereof. Moreover, the processes disclosed in each of the first to third embodiments can be realized in various aspects including, for example, a recording medium storing a program for executing the processes, and a method for executing the processes.

What is claimed is:

1. A printer configured to perform printing based on a print job received from an external device, in accordance with a plurality of setting values associated with the received print job, wherein
the printer is configured to:
notify the external device of resolution information in response to a first request from the external device, the resolution information being information to resolve a combination of setting values not to be associated with each other at a same time, the resolution information being information in which a specific setting value is set for a predetermined setting item, the specific setting value indicating that the printer replaces the specific setting value with another setting value;
select one setting value in accordance with a situation of the printer from a plurality of setting values with which the specific setting value is replaceable, in a case where the printer has notified the external device of the resolution information in response to the first request from the external device and then the printer receives a print job associated with the specific setting value from the external device; and
perform the printing based on the print job in accordance with the one setting value that has been selected.

2. The printer according to claim 1, wherein
the specific setting value includes a first specific setting value corresponding to a first setting item and a second specific setting value corresponding to a second setting item,
the first specific setting value is replaceable with one of a plurality of first setting values and the second specific setting value is replaceable with one of a plurality of second setting values, and
in a case where the printer has notified the external device of the resolution information in response to the first request from the external device and then the printer receives the print job associated with at least one of the first specific setting value and the second specific setting value from the external device, the printer is configured to:
select one setting value in accordance with the situation of the printer from the plurality of first setting values with which the first specific setting value is replaceable, in a case where the received print job is associated with the first specific setting value;
select one setting value in accordance with the situation of the printer from the plurality of second setting values with which the second specific setting value is replaceable, in a case where the received print job is associated with the second specific setting value; and
perform the printing based on the print job in accordance with the one setting value which has been selected.

3. The printer according to claim 2, wherein
the combination of the setting values not to be associated with each other at the same time includes a first combination and a second combination, and
in response to the first request from the external device, the printer is configured to:
notify the external device of the resolution information in which the first setting item has the first specific setting value, as the resolution information for the first combination; and
notify the external device of the resolution information in which the second setting item has the second specific setting value, as the resolution information for the second combination.

4. The printer according to claim 3, wherein in a case where the printer receives a “job-resolvers-supported” command as the first request from the external device in accordance with an Internal Printing Protocol standard, the printer is configured to notify the external device of the resolution information.

5. The printer according to claim 3, wherein
the combination of the setting values not to be associated with each other at the same time includes a first specific combination in which a size unsuitable for a specific sheet discharge tray is set for a sheet size and the specific sheet discharge tray is set for a sheet discharge tray, and
in response to the first request from the external device, the printer is configured to notify the external device of the resolution information in which the predetermined setting item is the sheet discharge tray and one of the plurality of first setting values is set for the sheet discharge tray as the specific setting value, as the resolution information resolving the first specific combination.

6. A printer configured to perform printing based on a print job received from an external device, wherein
the printer is configured to:
notify the external device of a state code indicating a current state of the printer, in response to a first request from the external device;
notify the external device of a reason code indicating a reason for the current state of the printer, in response to a second request from the external device; and
notify the external device of a first printer state message in which a state message and a reason message are combined, in response to a third request from the external device, the state message being composed in natural language indicating the current state of the printer, the reason message being composed in the natural language indicating the reason for the current state of the printer.

7. The printer according to claim 6, wherein
in a case where the current state of the printer is a predetermined state and a reason for the predetermined state is a predetermined reason, the printer is configured to display a state UI message composed in the natural language indicating that the printer is in the predetermined state and a reason UI message composed in the natural language indicating the predetermined reason, on a user interface of the printer, and
in a case where the printer receives the third request from the external device in a situation where the current state of the printer is the predetermined state and the reason for the predetermined state is the predetermined reason, the printer is configured to notify the external device of the first printer state message including the state UI message as the state message and the reason UI message as the reason message.

8. The printer according to claim 7, wherein
the reason for the predetermined state of the printer includes a first reason to be displayed on the user interface as the reason UI message and a second reason not to be displayed on the user interface as the reason UI message,
in a case where the printer receives the third request from the external device in a situation where the current state of the printer is the predetermined state and the reason for the predetermined state of the printer is the first reason, the printer is configured to notify the external device of the first printer state message including the state UI message as the state message and the reason UI message as the reason message, and
in a case where the printer receives the third request from the external device in a situation where the current state of the printer is the predetermined state and the reason for the predetermined state of the printer is the second reason, the printer is configured to notify the external device of a second printer state message including the state UI message as the state message and not including the reason message.

9. The printer according to claim 6, wherein
in response to the third request from the external device, the printer is configured to:
notify the external device of the first printer state message in which the state message and the reason message are combined, in a case where the reason code corresponding to the reason for the current state of the printer is not a special code; and
notify the external device of a third printer state message including the state message and not including the reason message, in a case where the reason code corresponding to the reason for the current state of the printer is the special code.

10. The printer according to claim 9, wherein the special code is the reason code indicating that the reason for the current state of the printer does not exist.

11. The printer according to claim 9, wherein the special code is the reason code indicating that the reason for the current state of the printer exists, whereas a code indicating the reason does not exist.

12. The printer according to claim 9, wherein the special code is the reason code with which a message is not associated.

13. The printer according to claim 6, wherein
the state code and the reason code are defined by a standard to which the external device conforms, and
the state message and the reason message are not defined by the standard to which the external device conforms.

14. The printer according to claim 6, wherein
in a case where the reason for the current state of the printer includes a plurality of reasons, the printer is configured to notify the external device of reason codes corresponding to the plurality of reasons respectively in response to the second request from the external device, and
in a case where the printer receives the third request from the external device and the reason for the current state of the printer includes the plurality of reasons, the printer is configured to notify the external device of the first printer state message in which the state message and reason messages corresponding to the plurality of reasons respectively are combined.

15. The printer according to claim 14, wherein in the case where the printer receives the third request from the external device and the reason for the current state of the printer includes the plurality of reasons, the printer is configured to notify the external device of the first printer state message including the state message and the reason messages corresponding to the plurality of reasons respectively, within a range in which the number of characters of the first printer state message does not exceed an upper limit value.

16. The printer according to claim 6, wherein
in a case where the reason for the current state of the printer includes a plurality of reasons, the printer is configured to notify the external device of reason codes corresponding to the plurality of reasons respectively in response to the second request from the external device, and
in a case where the printer receives the third request from the external device and the reason for the current state of the printer includes the plurality of reasons, the printer is configured to notify the external device of the first printer state message in which the state message and a reason message corresponding to one reason selected from the plurality reasons are combined.

17. The printer according to claim 6, wherein
in response to the third request from the external device, the printer is configured to:
notify the external device of the first printer state message in which the state message and the reason message are combined, in a case where a combination of the current state of the printer and the reason for the current state of the printer is not a specific combination; and
notify the external device of a fourth printer state message including the reason message and not including the state message, in a case where the combination of the current state of the printer and the reason for the current state of the printer is the specific combination.

18. The printer according to claim 17, wherein the specific combination is a combination in which the state message indicating the current state corresponds with at least a main part of the reason message indicating the reason.

19. The printer according to claim 6, wherein
in accordance with an Internet Printing Protocol standard, the printer is configured to:
notify the external device of the state code, in a case where the printer receives a “printer-state” command as the first request from the external device;
notify the external device of the reason code, in a case where the printer receives a “printer-state-reasons” command as the second request from the external device; and
notify the external device of the first printer state message, in a case where the printer receives a “printer-state-message” command as the third request from the external device.

20. The printer according to claim 6, wherein
the current state of the printer includes a current state of a predetermined job inputted to the printer, and
the printer is configured to:
notify the external device of the state code indicating the current state of the predetermined job, in response to the first request from the external device with respect to the predetermined job;
notify the external device of the reason code indicating a reason for the current state of the predetermined job, in response to the second request from the external device with respect to the predetermined job; and
notify the external device of a first job state message in which the state message and the reason message are combined, in response to the third request from the external device with respect to the predetermined job, the state message being composed in the natural language indicating the current state of the predetermined job, the reason message being composed in the natural language indicating the reason for the current state of the predetermined job.

21. The printer according to claim 20, wherein
in accordance with an Internet Printing Protocol standard, the printer is configured to:
notify the external device of the state code, in a case where the printer receives a “job-state” command as the first request from the external device;
notify the external device of the reason code, in a case where the printer receives a “job-state-reasons” command as the second request from the external device; and
notify the external device of the first job state message, in a case where the printer receives a “job-state-message” command as the third request from the external device.

22. A printer configured to perform printing based on a print job received from an external device, wherein
the printer is configured to:
notify the external device of a state code indicating a current state of a predetermined job inputted to the printer, in response to a first request from the external device with respect to the predetermined job;
notify the external device of a reason code indicating a reason for the current state of the predetermined job, in response to a second request from the external device with respect to the predetermined job; and
notify the external device of a first job state message in which a state message and a reason message are combined, in response to a third request from the external device with respect to the predetermined job, the state message being composed in natural language indicating the current state of the predetermined job, the reason message being composed in the natural language indicating the reason for the current state of the predetermined job.
